(19) United States
(12) Patent Application Publication
(10) Pub. No.: US 2010/0042490 A1
(43) Pub. Date: Feb. 18, 2010

(54) Electronic Coupon Distribution System

(76) Inventor: Steven R. Boal, Los Altos, CA (US)

Correspondence Address: John W. Rees;RADER, FISHMAN & GRAUER PLLC, Suite 140, 1533 North Woodard Avenue, Bloomfield Hills, MI, 48304, US

(21) Appl. No.: 12/603,485

(22) Filed: Oct. 21, 2009

Related U.S. Application Data
(63) Continuation of application No. 09/451,160, filed on Nov. 30, 1999, now abandoned.
Application No. 09/451,160 is a continuation of application No. 10/439,237, filed on May 16, 2003.
Application No. 10/439,237 is a continuation of application No. 11/372,243, filed on Mar. 8, 2006.

(51) Int. Cl. G06Q 30/00; G06Q 10/00

(52) U.S. Cl. 705/14.22; 705/14.26; 705/14.35

(57) ABSTRACT

A method of secure electronic couponing is disclosed which includes a main server system, and a client system interconnected by a distributed computer network, such as the Internet. Coupon data and advertising data are encrypted to thereby reduce the likelihood that such data may be misused, such as by unauthorized duplication. In addition, the client system is identified by a user identification that is allocated and associated with user information collected from the user of the client system. The user information is indicative of one or more demographic characteristics of the user without being sufficiently personal to specifically identify the user, thus preserving privacy. An icon is provided which, when flashing, alerts the user to the fact that new coupons are available.

### BACKGROUND OF THE INVENTION

1. Technical Field

The present invention relates generally to a system and method for coupon distribution, and, more particularly, to an electronic coupon distribution system.

2. Description of the Related Art

Every year, several hundred billion coupons are circulated in the United States. Nearly all are distributed using traditional “scatter gun” approaches, such as those included in Sunday circulars and direct mailings. However, consumers waste time clipping coupons that expire, or accumulate for years in undesirable places, such as kitchen drawers. Moreover, such traditional methods of coupon distribution do not effectively reach the ever increasing group of consumers that use public computer networks, such as the World Wide Web portion of the Internet (the “web”).

One approach taken in response to these and other shortcomings involves providing for coupon delivery over the Internet, as seen by reference to U.S. Pat. No. 5,855,007 entitled “Electronic Coupon Communication System” issued to Jovicic et al. Jovicic et al. disclose a system for generating and redeeming unique product discount coupons over public computer networks such as the Internet. Jovicic et al. further disclose that the user of such a system must be registered in order to obtain the coupons, wherein registration requires the user to provide information sufficient to specifically identify a user, such as the user's name, address, Internet e-mail address, identification number, and the like. Jovicic et al., further disclose an Internet coupon server and a user display terminal in communication therewith. Once a displayed electronic coupon is selected by the user, the coupon server sequentially transmits the coupon's digital data pattern to the user's printing device. There are, however, numerous shortcomings to the system disclosed in Jovicic et al., as well as other, such as that disclosed in U.S. Pat. No. 5,761,648 to Golden et al.

First, known electronic coupon distribution systems require registration, which in turn requires that the user provide personal information. Users generally dislike providing such personal information as a matter of privacy, and, in any event, once obtained, such personal information is subject to further dissemination against the wishes of the user, through accident, inadvertence, omission, or otherwise. Users who have privacy concerns may avoid registering with such systems, which is undesirable from both the system proprietor's point of view, as well as the coupon sponsor's point of view. In addition, in known electronic coupon distribution systems, inadequate measures are taken to protect the coupon data. This sometimes results in more than the authorized number of the coupons being printed out for use (i.e., redemption). This outcome is essentially a fraud on the coupon sponsor. For example, in known web-based coupon distribution systems, the HTML (Hyper-Text Mark Up Language) code corresponding to the selected coupon provides inadequate protection (i.e., the HTML code can be intercepted). In addition, in known electronic coupon distribution systems, some electronic coupons are distributed by “clicking” on an ad banner or the like, which automatically directs the browser to a predetermined web URL (Uniform Resource Locator) via a “link”, which includes an appended promotional code. While the intent of the e-coupon provider is to obscure the specified URL/Promotional code, in practice, such “protection” is easily defeated. In some instances, moving the mouse arrow over the ad/coupon will cause the “link” to be displayed on the user's monitor. In other instances, “right-clicking” on the ad/coupon makes the “link” (including the code) available for capture by the user. The captured URL can then be “posted” or e-mailed to others. As a result, unintended and unauthorized recipients will have access to the electronic coupon. Finally, electronic coupons that are cached or otherwise stored locally at the user's location are susceptible to misuse (i.e., being retrieved and reprinted outside of the system coupon browser provided by the coupon distributor). Overall, known electronic coupon distribution systems are relatively insecure in their ability to prevent fraud.

Another disadvantage of known electronic coupon distribution systems is that they require that the user be “online” to browse and select coupons. While Golden et al. provides the capability of printing coupons after disconnecting from the online system, such coupons are limited only to those selected while the user was online—that is, all coupon selection must occur while online. In addition, known electronic coupon systems require active intervention to obtain updated coupon and offer information.

There is therefore a need for an improved electronic coupon distribution system that minimizes or eliminates one or more of the shortcomings as set forth above.

### SUMMARY OF THE INVENTION

One advantage of an electronic coupon distribution system in accordance with the present invention is that it ensures the privacy of its users by only collecting user information indicative of demographic characteristics of the user without obtaining information sufficient to specifically identify the user. The system therefore has the needed information to identify coupons appropriate for the user based on such user's demographic characteristics. Another advantage of the present invention is that it provides secure electronic coupon distribution through encryption of coupon information. Yet another advantage of the present invention is that it is configured to automatically update a client system through which the user interacts with new coupon data without any intervention by the user. Still yet another advantage of the present invention involves the deployment of a visual alert to inform the user of new coupon availability. In particular, the remote client system is configured to operate in accordance with an operating system (OS) characterized by a graphical user interface (GUI) wherein the client system includes an icon displayed in a different state (e.g., “flashing”) when new coupons are available for the user.

These and other features and advantages are realized by a method of operating an electronic coupon distribution system comprising several basic steps. The first step involves collecting user information from a user of a client system indicative of one or more demographic characteristics of the user without obtaining information sufficient to specifically identify the user. The next step involves associating at a main server system a user ID with the collected user information. Next, selecting coupons according to the user ID to thereby identify coupons appropriate for the user based on the user's demographic characteristics. Finally, the last step involves transmitting the selected coupons from the server system to the client system.

In a preferred embodiment, the user demographic characteristics include at least one of a postal zip-code associated with the user and the state in which the user resides. By avoiding obtaining information sufficient to specifically identify the user, privacy is maintained.

In yet another preferred embodiment, coupon data at the server system is encrypted in accordance with a server system encryption strategy prior to being sent to the client system. This step minimizes the chance of coupon fraud. In a further embodiment, the encrypted coupon data as received at the client system is further encrypted in accordance with a client system encryption strategy to thereby generate doubly encrypted coupon data prior to being stored on the client system.

In yet a further embodiment, the client system transmits a request to the server system to provide updated coupon information automatically without any intervention by the remote user to thereby define a “persistent” client having automatic coupon delivery.

Other objects, features, and advantages of the present invention will become apparent to one skilled in the art from the following detailed description and accompanying drawings illustrating features of this invention by way of example, but not by way of limitation.

### BRIEF DESCRIPTION OF THE DRAWINGS

FIG. 1 is a diagrammatic and block diagram view of an electronic coupon distribution system in accordance with the present invention;

FIG. 2 is a simplified block diagram showing, in greater detail, a database server portion of the main server system shown in FIG. 1;

FIGS. 3A-3B illustrate a screen display defining an interface associated with a client system portion of the present invention;

FIG. 4 is a simplified flowchart diagram view illustrating interactions between the client system, and the main server system in accordance with the present invention;

FIG. 5 is a simplified flowchart diagram view showing, in greater detail, the initial steps illustrated in FIG. 4 for system initialization;

FIG. 6 is a simplified flowchart diagram view showing, in greater detail, an echo request step shown in block diagram form in FIG. 5;

FIG. 7 is a simplified flowchart diagram view showing a server selection routine performed at the main server system;

FIG. 8 is a simplified flowchart diagram view showing the steps for registration of a new user on the main server system;

FIGS. 9-11 are simplified flowchart diagram views showing, in greater detail, the steps of updating the master category list, plugins, and brand logo information, respectively, that are shown in block diagram form in FIG. 4;

FIG. 12 is a simplified flowchart diagram view showing, in greater detail, the step of updating advertising data that is shown in block diagram form in FIG. 4;

FIG. 13 is a simplified flowchart diagram view showing, in greater detail, the step of updating coupon data that is illustrated in block diagram form in FIG. 4;

FIG. 14 is a simplified flowchart diagram view showing, in greater detail, the step of updating the main server system with a user history file that is shown in block diagram form in FIG. 4;

FIG. 15 is a simplified flowchart diagram view showing the steps involved in obtaining a client script;

FIGS. 16-17 are simplified flowchart diagram views showing alternate responses taken by the client system in response to double-clicking a taskbar icon according to the invention;

FIG. 18 is a simplified flowchart diagram view showing timing mechanisms for automatically updating coupon data without user intervention;

FIGS. 19-20 are simplified flowchart diagram views showing alternate actions taken by the client system in response to selection by the user of a logo pane and an advertising pane, respectively;

FIG. 21 is a simplified flowchart diagram view showing the steps executed by the client system when a user selects an item from a coupon subcategory list;

FIG. 22 is a simplified flowchart diagram view showing the steps executed by the client system when the user selects a particular coupon; and,

FIG. 23 is a simplified flowchart diagram view showing the steps executed by the client system when a coupon is selected and added to a print cart.

### DETAILED DESCRIPTION OF THE PREFERRED EMBODIMENTS

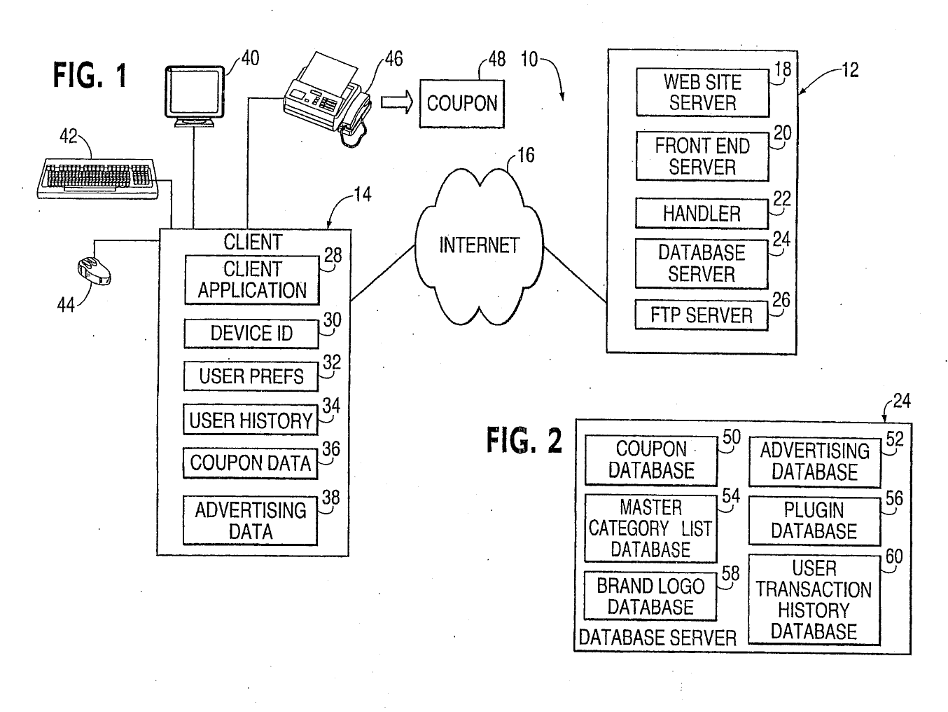

Referring now to the drawings wherein like reference numerals are used to identify identical components in the various views, FIG. 1 shows an electronic coupon distribution system 10 in accordance with the present invention. Electronic coupon distribution system 10 includes a main server system 12 and a client system 14 that is remote from main server system 12, connected together by a distributed computer network, such as the Internet 16. A user desiring to obtain electronic coupons uses client system 14 to interact with main server system 12 to obtain is electronic coupons.

Main server system 12 is configured to be connected to, or otherwise receive, coupon information from the issuer of such coupons (i.e., the coupon's sponsor). Although not shown, this function may be performed by a direct electronic connection with a sponsor system, or may involve loading data from a physically transportable data storage medium (e.g., diskette, tape, CD-ROM, etc.). The coupon sponsor may, and in most cases will, issue in connection with the coupon an associated set of instructions that define how the coupon is to be distributed. For example, such instructions may include restrictions as to the number of coupons that any one user may print out for redemption, the state and/or zip code associated with a user for such user to have access to the coupon, the expiration date, the item and discount amount, etc. Main server system 12 is further configured to be connected to, or otherwise receive, advertising information from an advertising sponsor. Although not shown, this function may be performed by direct electronic connection with the ad sponsor's system, or may involve loading data from a physically transportable data storage medium (i.e., diskette, tape, CD-ROM, etc.). The advertising impressions are displayed on client system 14, as described in greater detail below.

Main server system 12 may include a website server 18, a front-end server 20, a handler 22, a database server 24, and an FTP server 26.

Website server 18 is configured to provide “web pages” to consumers (including possible users of system 10) with Internet access. Internet 16, more particularly, the World wide Web portion thereof, “WWW”, is an interconnected computer network that is generally distributed throughout the world on discrete interconnected computer nodes having software interfaces generally referred to as “web pages”. Access to Internet 16 can be made by various methods; typically, however, a non-institutional user obtains access from one of a plurality of Internet Service Providers (ISPs), which in turn obtain authorized access to Internet 16. Navigation on the WWW portion of Internet 16 involves knowledge of a directory structure of various nodes of the Internet (i.e., an “address” to each given resource on Internet 16). Such an address is generally referred to as a Uniform Resource Locator (URL), which typically starts with a protocol name followed by a domain name, for example: http://www.valuepass.com. Website server 18 is configured to provide, among other things, an interface for effecting a download of client software that a consumer may download and execute to establish a client system 14 on his or her computer system. In this way the consumer may become an authorized user (“user”) of system 10. In particular, website server 18 may refer an Internet consumer to FTP server 26 for the client installation file. Website server 18 may comprise conventional apparatus known to those of ordinary skill in the art, and will therefore not be described in any further detail.

Front-end server 20 provides multiple-interface and allocation/direction features for electronic coupon distribution system 10. Front-end server 20 in the entity that is initially contacted by client system 14 at the start of each new session of system 10, or when automatic coupon updates occur. Front-end server 20 may comprise conventional apparatus known to those of ordinary skill in the art.

Handler 22 is configured to interface with database server 24. After a new session is established by a user, all subsequent requests by client system 14 are directed to and are “handled” by handler 24. As a result, handler 24 may thereafter issue a request or a command to database server 24, or directly respond to client system (if configured to do so). Handler 22 may comprise conventional apparatus known in the art.

Database server 24 may comprise a plurality of physical, individual general purpose digital computers configured as database servers, which may be further configured in a cluster arrangement. Database server 24, in one embodiment, may be configured to operate using SQL server software, such as Microsoft SQL Server Version 7, commercially available from, for example, Microsoft Corporation, Redmond, Wash. U.S.A.

FTP server 26 may be configured to operate in cooperation with website server 18 to provide, for example, installation or setup programs. The installation program(s) are downloaded to a general-purpose computer (e.g., PC or a MAC) for installation of the client software in accordance with the present invention. FTP server 26 may comprise conventional apparatus known to those of ordinary skill in the art.

Client system 14 includes client application software 28, user identification (ID) data 30, user preference data 32, user history data 34, coupon data 36, and advertising data 38. In addition, client system 14 may comprise conventional, general purpose computing apparatus configured to operate in accordance with an operating system having a graphical user interface, such as, for example, Windows 95/98/NT 4.0, and Apple Computer, Inc.'s. MAC OS Operating System for Macintosh platforms. Client system 14 may further include standard peripherals such as a display device 40, a monitor 40, a keyboard 42, a pointing device, such as a mouse 44, and an output device, such as a printer 46, for producing a “hard copy” of a selected coupon 48.

Client application 28 comprises software compatible with and executing on client system 14 configured to implement the present invention as described herein. Client application 28 performs various functions including, but not limited to, collecting user information, including preferences, communicating with main server system 12 via Internet 16, and providing an interface for the user for browsing through, and selecting, coupons for printout.

User identification ID 30 may comprise a multi-digit number that is assigned by main server system 12, more particularly, database server 24, when a user registers with coupon distribution system 10. User ID 30 may have a format, such as XXX/XXXXXXXX, where X is a digit between 0-9. The user ID, however, does not specifically identify the user personally, but rather, more accurately associates a physical machine defining client system 14 with user profile information obtained during registration. User identification 30 is stored on client system 14 as a part of a UserInfo object, and is provided to main server system 12 when making requests, for example, for new coupon data. Main server system 12 can then correlate the provided user ID 30 with user information stored in a profile database. The user information may then be used in identifying coupons suitable for the user. Significantly, however, the user is not personally identified nor is it even possible (e.g., through the “hacking” of server system 12) to identify the user personally, as such information is not even collected from the user. Accordingly, the approach described herein maintains privacy of the user of system 10.

The UserInfo object further includes user information collected from the user of client system 14 indicative of one or more demographic characteristics of the user. Significantly, the user information is insufficient to specifically identify the user. In a constructed embodiment, such information comprises a postal zip code associated with the user, and a state in which the user resides. Client application 28 allows the user to update this information after initial registration. In addition, the UserInfo object includes the mode in which the Internet is accessed, for example, through use of a modem (e.g., dial-up), through use of a Local Area Network (LAN), or use of a proxy server. The UserInfo object may further include the version number of the client application software 28.

User preference data 32 comprises two main groups. The first group of information contained in user preference data 32 includes information defining how often the main server system 12 is checked for new coupons. In a constructed embodiment, the options include one hour, two hours, four hours (the default), twice a day, and once a day. The first group of information contained in user preference data 32 may also include a miscellaneous item of information indicating whether the user prefers that certain coupons be automatically printed (this may be selected or deselected by the user). The second main group of information included in user preference data 32 includes a comprehensive listing of main categories of coupons selected by the user that the user wishes to receive. While the particular main coupon category descriptions may be changed on main server system 12 and downloaded to client system 14 at any time, exemplary categories include “Apparel”, “Athletics”, “Automotive”, and “Internet Electronics”, among others. A user can deselect a category, in which case coupons pertaining to that category will not be sent from main server system 12 to client system 14.

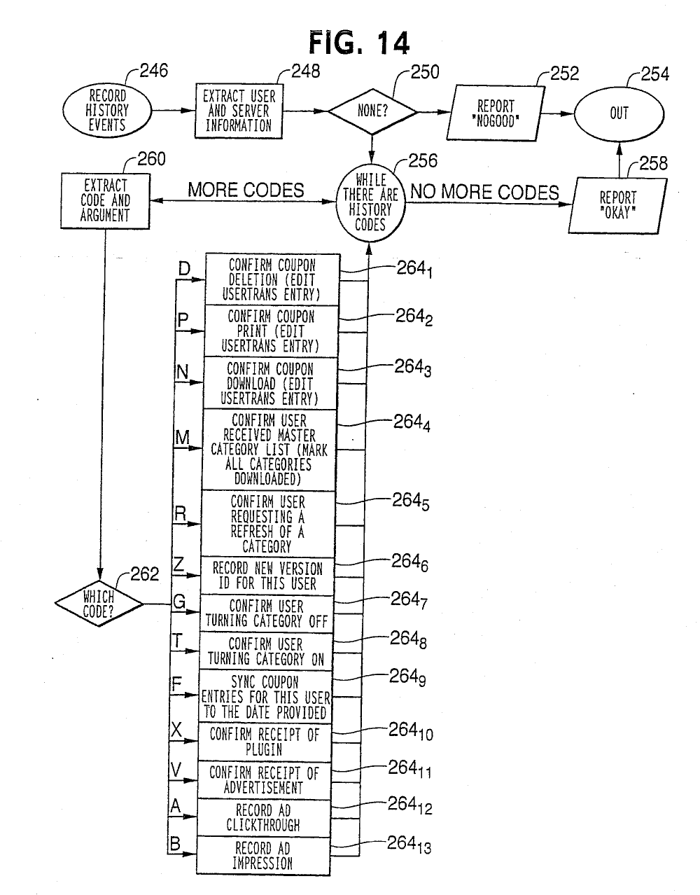

User history data 34 comprises data corresponding to events occurring at the remote client system 14, as well as other items pertaining to the operation of client system 14. All these items are stored in a user history file. For example, when a user is browsing through available coupons, each coupon that is selected for viewing is noted in the user history file. Likewise, when a coupon is selected for printing, that action is also recorded in the user history file. Other examples include when a coupon is actually printed, and when an advertising impression (described in further detail below) is displayed on display 40. The information contained in the user history file 34 is encrypted by client application 28 in accordance with a client system encryption strategy to protect the integrity of the data contained therein. The contents of the user history file 34 will be described and illustrated in greater detail in connection with FIG. 14.

Coupon data 36 includes information corresponding to the electronic coupons available (e.g., for browsing) on client system 14. Each electronic coupon, such as coupon 48, includes a plurality of items of information associated therewith. Therefore, a structure is defined for each electronic coupon having the items of information set forth in Table 1 below.

TABLE 1
Electronic Coupon Data Structure

| | |
|---|---|
| 1. | Electronic Coupon Sponsor Name |
| 2. | Product or Service Description |
| 3. | Savings or Discount Amount |
| 4. | The Number of Electronic Coupons Available for Printout |
| 5. | The Number of Electronic Coupons Printed Out Thus Far |
| 6. | Expiration Date |
| 7. | Optional Text/Image(S) |
| 8. | Coupon Identification Number |

In addition, when a coupon 48 is actually printed out, additional information may be printed out on the “hard copy” of the electronic coupon. These additional items may include the user ID 30, portions of the demographic data such as the postal zip code, one or more items of the user information contained in user preference data 32, the date and time, and optionally various Internet URLs. Coupon sponsors have found some of the information appearing on printed coupon 48 desirable. That is, when the user redeems a coupon 48, for example, at a retail store, information appearing on coupon 48 (which is eventually returned by the retailer to the coupon issuer or sponsor) is available to the coupon sponsor. This information may thereafter be used in analyzing and assessing the efficacy of various advertising/promotional strategies. Coupon data 36 may be stored on a hard drive or the like associated with client system 14, and is preferably stored in an encrypted form. In particular, and in accordance with the present invention, coupon data 36 corresponding to electronic coupons is encrypted by main server system 12 in accordance with a server system encryption strategy. The encrypted coupon data is then transmitted to client system 14. Client system 14 further encrypts the once-encrypted coupon data in accordance with a client system encryption strategy to thereby generate doubly encrypted coupon data. The doubly encrypted coupon data 36 may then be stored on the client system 14. The foregoing encryption steps substantially minimize the occurrence of fraud in the distribution of electronic coupons compared to known systems. A user, for example, can therefore not easily defeat the coupon counting scheme that limits the number of printouts by, for example, exploring the client system's hard drive, identifying coupon data, and thereafter producing printed copies of the coupons. Use of the environment established by client application software 28 is therefore practically the only means for the user to obtain usable coupons 48.

Advertising data 38 comprises a plurality of advertising impressions wherein each impression may include a predetermined is combination of text and images. Advertising data 38 is also stored on client system 14 in an encrypted form.

Display 40, keyboard 42, mouse 44, and printer 46 may comprise conventional apparatus known to those of ordinary skill in the art.

FIG. 2 shows, in greater detail, database server 24 of main server system 12. As described above, database server 24 may comprise a plurality of physical database servers arranged in a cluster. Further physical machines may be added to provide for load balancing (i.e., scalability, and the ability to quickly add additional hardware as load and responsiveness criteria require). Database sever 24 may include a coupon database 50, an advertising database 52, a master category list database 54, a plugin database 56, a brand logo database 58, and a user transaction history database 60.

Coupon database 50 includes coupon data similar to that described in connection with coupon data 36, but is more in the nature of a master coupon database including the entire universe of electronic coupons available on electronic coupon distribution system 10.

Advertising database 52 includes a plurality of ad impressions, which may be a combination of text and/or images. Again, advertising database 52 is in the nature of a master advertising database including all of the advertising impressions included in main server system 12.

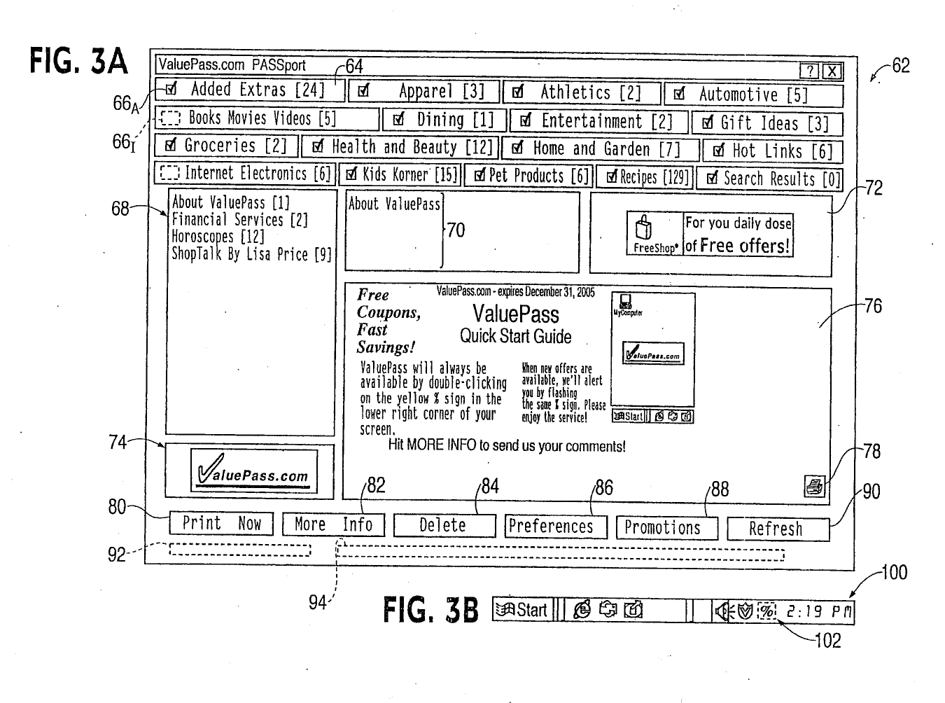

Master category list database 54 includes the main coupon category names presently established on electronic coupon distribution system 10. In addition, display characteristics, such as the color of a main coupon category button (to be described in connection with FIG. 3A) may also be stored in database 54.

Plugin database 56 includes information as to available plugins for use in connection with client application 28 of client system 14. Plugin database 56 includes a plurality of plugins. The particular plugins that are selected for use in connection with client application 28 depends on what added functionality has been configured in system 14. For example, plugins may be configured to provide Zodiac information, recipe information, and stock quote information to the user. Additionally, a plugin may be configured to provide a new coupon style for the user. In this way, client system 14 can be updated remotely with new functionality.

Brand logo database 58 includes information as to how the user interface of client system 14 is “branded”. The default “branding” of the user interface involves the display of a company logo of the assignee of the present invention. Also, a corresponding Internet URL for “clickthrough” purposes is associated with the brand image. However, in alternate embodiments, other companies may arrange (e.g., through a referral of potential new users of electronic coupon distribution system 10) to have the user interface of client application 28 “branded” with the referring company's logo (and Internet URL for “clickthrough”).

User transaction history database 60 includes information contained in user history file 34 uploaded from client system 14. User transaction history database 60 therefore contains information corresponding to actions or events taken by or involving the user of client system 14. Database 60 therefore includes a record for each coupon that has been downloaded or otherwise provided to client system 14. As each coupon is displayed, or printed by the user, for example, the corresponding record in database 60 is updated.

Referring now to FIGS. 3A and 33, FIG. 3A shows a Graphical User Interface (GUI) 62 displayed on display 40 in connection with to the execution of client application software 28. Interface 62 includes a plurality of main coupon category “buttons” 64 each having a respective status indicator 66 associated therewith. Interface 62 also includes a coupon subcategory list 68, a coupon list 70, an advertising pane 72, a logo pane 74, a main coupon display area 76, an “Add-To-Print-Cart” button 78, a “Print Now” button 80, a “More Info” button 82, a “Delete” button 84, a “Preferences” button 86, a “Promotions” button 88, a “Refresh” button 90, a printout status display area 92, and a general message display area 94.

Main coupon category buttons 64 allow the user of client system 14 to select the general category of coupons that the user is interested in viewing. For example, the user who is interested in browsing through entertainment coupons, would select the main category button 64 designated “Entertainment” using, conventionally, a pointing device such as mouse 44 (e.g., via “clicking” on the button). Status indicator 66 associated with each main coupon category button 64 indicates whether there are coupons under that main category that have not yet been displayed in display area 76. As shown in FIG. 3A, when a status indicator 66 is “checked” (i.e., active), as indicated generally at 66_{A} for the main coupon category button labeled “Added Extras”, such indication informs the user that coupons are available under that main coupon category that have not yet been displayed. Alternatively, when there are no undisplayed coupons under a main category, the “checked” status indicator 66 becomes inactive and is removed, as shown by a dashed line box designated 66, where a status indicator would otherwise be displayed had it been “active”.

When one of the plurality of main coupon category buttons 64 is selected, a corresponding subcategory list is displayed in subcategory list 68. A user may then browse through the items contained in subcategory list 68 and make a selection. When one of the items contained in subcategory list 68 is selected by the user (e.g., via “clicking”), the corresponding individual coupons or informational messages are displayed in coupon list 70. The user may then select an item from coupon list 70, which will then be displayed in coupon display area 76. Through the foregoing interface, users of system 10 can quickly and easily navigate from broad main coupon categories, to, individual coupons, for printout and later redemption. If the user desires to print out a particular coupon, the user can select the print cart button 78 to add the selected coupon to a print cart or queue for subsequent printout on printer 46. Alternatively, the user may print the selected coupon immediately by selecting the “Print Now” button 80.

Advertising pane 72 is configured to display an advertising impression. In one embodiment, the advertising impression is selected from a plurality of advertising impressions as a function of a selected coupon subcategory. For example, a vendor of electronic equipment may arrange to have an ad impression for that vendor's company displayed in advertising pane 72 when the user selects a particular coupon subcategory from list 68 when the “Internet Electronics” category button 64 is selected. As a further feature, the advertiser may provide an Internet URL (e.g., to its home page) and have it associated with the ad impression. Client application 28 is configured such that when a user selects (e.g., “clicks”) advertising pane 72, an Internet browser program associated with client system 14 is launched and is directed to the URL as specified by the advertiser. This is a so-called “clickthrough” occurrence, which is recorded in the user history file.

Logo pane 74 provides a display area through which the user interface 62 of system 10 can be “branded”. As with advertising pane 72, an Internet URL may be associated with the brand logo displayed in logo pane 74. Client application 28 is configured such that when the user selects (e.g. “clicks”) logo pane 74, an Internet browser program associated with client system 14 is launched and is directed to the specified URL.

The “Print Now” button 80 is configured under client application 28 such that when selected, the coupon currently being viewed is printed out on printer 46. If there are one or more other coupons currently in the print queue, as a result of prior selection of the print cart button 78 for previously displayed coupons, then selection of the “Print Now” button 80 by the user will operate to print all such selected coupons 48 on printer 46.

The “More Info” button 82 is configured under client application 28 to launch an Internet browser program associated with client system 14 when selected, and, further, to direct the browser to a specified URL. In accordance with a secure e-couponing embodiment of the present invention, predetermined ones of the coupons displayed in coupon display area 76 may be redeemed by the user electronically (as opposed to printing out the displayed coupon and physically tendering the same to the retailer). Generally, a portion of the coupon being displayed in display 76 will tell the user to click on the “More Info” button 82 to instantly redeem the coupon. Client application 28 is configured to invoke, in response to the “click”, the specified but completely hidden and inaccessible URL (including the appended promotional code) using an Internet browser program. Client application 28 disables access to the invoked URL/code. For example, moving the mouse arrow over the coupon/ad does not cause the URL to be displayed, nor is “right-button clicking” operative to allow capture of the URL. Accordingly, the specified URL (and code) is neither displayed nor available, and cannot be discovered by, for example, “right-clicking” on coupon display 76, like conventional web-based e-coupon distribution systems. The browser takes the user to the website corresponding the specified URL, where the appended promotional code is processed, and the user provided an opportunity to redeem the same. The present invention therefore provides secure electronic coupon distribution. In another embodiment, the specified URL that is invoked when the “More Info” button 82 is “clicked” comprises the URL associated with an advertiser's website (i.e., the advertiser associated with an ad impression displayed in advertising pane 72).

The “Delete” button 84 is configured under client application 28 to delete the currently viewed coupon when selected by the user.

The “Preferences” button 86 is configured under client application 28 to allow the user to set and/or modify the information contained in the user preference data 32, when selected by the user. For example, the refresh interval referred to above may be updated by the user to extend or foreshorten the coupon update interval.

The “Promotions” button 88 is configured under client application 28 to prompt the user to enter a promotion code to obtain a special promotion coupon, when selected by the user. For example, a third-party website, or the like, may advise the user of a promotional code, with instruction to establish a client system 14 (if they are not already a registered user), and then to enter the promotion code as described above, to obtain the promotional coupon.

The “Refresh” button 90 is configured under client application 28 to transmit an update request from client system 14 to main server system 12, when selected by the user. This action, in-effect, requests that any new coupons waiting for the user on main server system 12 at that point in time be downloaded to client system 14. Additionally, any data in the user history file is uploaded.

Print status display area 92 is provided for displaying messages pertaining to the status of the print cart (e.g., “Items to Print: 2”).

Message display area 94 is provided for displaying various messages to the user of client system 14.

Referring now to FIG. 3B, the graphical user interface associated with the operating system of client system 14 may include a taskbar 100. In accordance with the present invention, a taskbar icon 102 is provided. Client application software 28 is configured to display taskbar icon 102 to the user in a first display state when no new coupons or messages are available to the user. Icon 102 in the first display state may assume a static display. In constructed embodiment, taskbar icon 102 includes a generally black-colored “%” symbol on a yellow-colored background, all enclosed by a dashed-line box. Client application software 28 is further configured to display taskbar icon 102 in a second display state different from the first display state when new coupons or messages are available for the user. In a constructed embodiment, the second display state associated with taskbar icon 102 comprises a quasi-flashing display state wherein (i) the color of the “%” symbol is indexed or rotated through a plurality of different colors, and (ii) the dashed-line enclosure box is manipulated to give the sense of movement, particularly rotation, around the perimeter of icon 102.

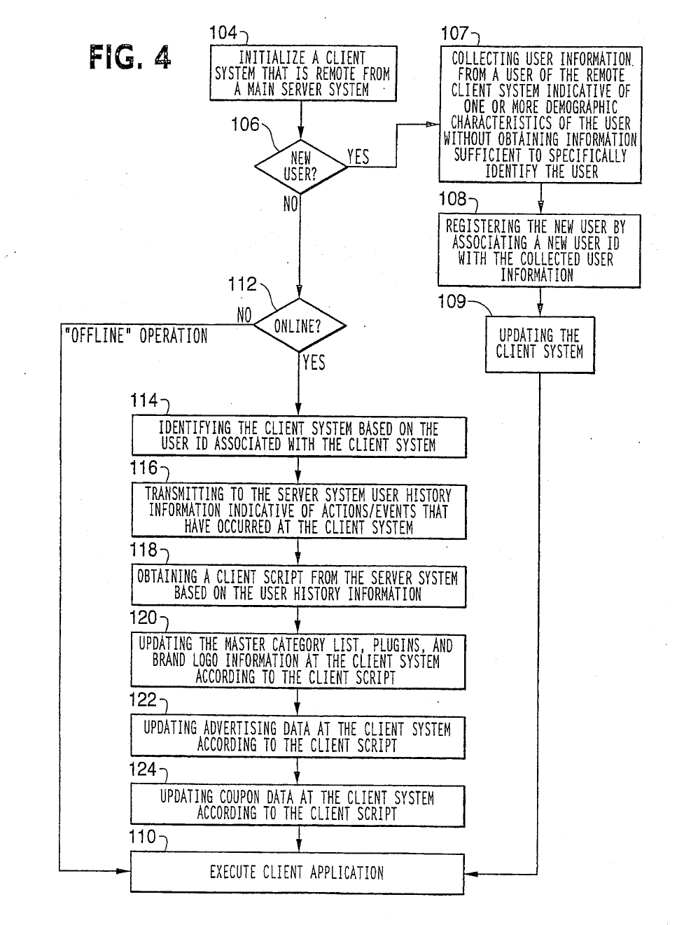

Referring now to FIG. 4, a brief description of the operation of system 10, particularly the main interactions between client system 14 and main server system 12, will now be set forth. Each time a new session is commenced, the basic steps set forth in FIG. 4 will be performed.

In step 104, client system 14, by way of execution of client application software 28, is initialized.

In step 106, client application 28 determines whether there is an identified user for client system 14, or whether the present user is a “new” user. Client application 28 may make this determination based on the existence or absence of particular files on client system 14 (e.g., a file containing a user ID 30) indicative of whether or not this is a “new” user. If “NO”, then the method branches to step 112. Otherwise, if the answer to step 106 is “YES”, then the method branches to step 107.

In step 107, client application 28 obtains user information from the user. In particular, client application 28 is configured to collect user information from a user of client system 14 indicative of one or more demographic characteristics of the user without obtaining information sufficient to specifically identify the user. In a constructed embodiment, the information obtained comprises a postal zip code associated with the user, and a State where the user resides. Personal information such as the user's name, e-mail address, residence address, social security number, telephone number, and the like is not obtained in step 107. In accordance with the present invention, the foregoing step provides useful information to main server system 12 in the selection of coupons appropriate for the user (e.g., geographic area). Coupons from merchants located geographically proximate the user's residence may be more easily redeemed by the user, thus increasing the efficacy of the coupon offer. Other information, such as the type of Internet connection (e.g., modem), may also be obtained from the user in step 107.

In step 108, main server system 12 registers the “new” user. Server system 12 determines whether the user of remote client system 14 is a “new” user based on the presence or absence of a user ID 30 in a message from client system 14 to server system 12. The “new” user is then registered on main server system 12. Main server system 12 is configured to register the new user by performing, among other things, the steps of allocating a new user ID, and associating the new user ID with the user information obtained in step 107. Through the foregoing, remote client system 14 can always be identified by its user ID.

In step 109, client system 14 and main server system 12 communicate so as to update the master category list, plugins, brand logo information, advertising data and coupon data at the remote client system 14. This is done, for the first time the application 28 is executed, by searching the main server system 12 for new information that has come into being between the time the installation or setup program that the user used to install client system 14 was populated with such data (the “sync” date), and the present time (the server date). The identified information is downloaded to thereby update client system 14. This step ensures that the user of client system 14 has the most up-to-date information in these categories. The method then proceeds to step 110 wherein main application 28 is executed.

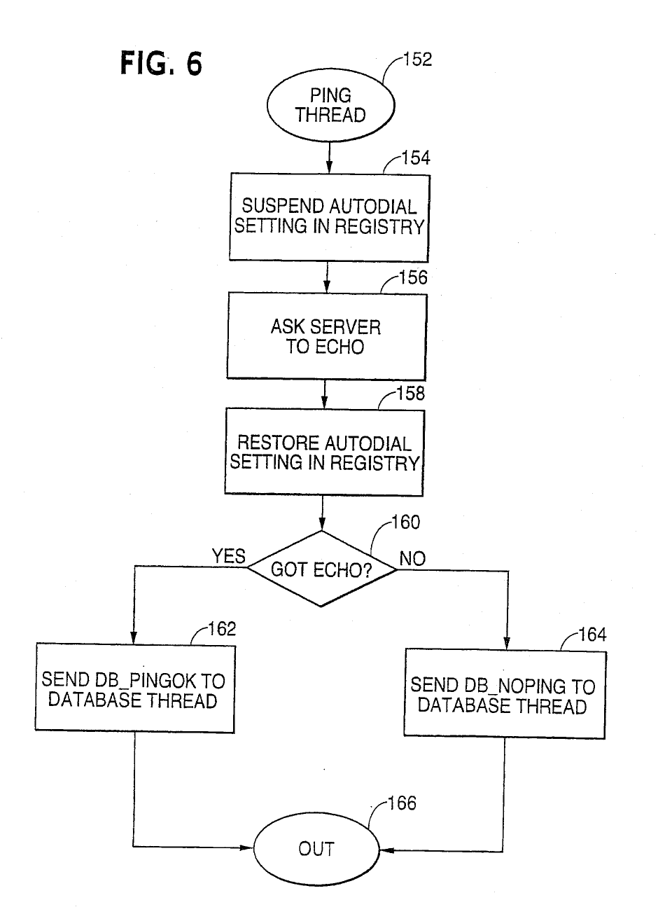

When the answer to step 106 is “NO”, then the method branches to step 112. In step 112, client application determines whether client system 14 is “online”. Client system 14 is “online” when the user is connected to the Internet such that client system 14 can communicate with main server system 12. While this basic step will be described in greater detail below (FIG. 6), it bears emphasizing that client system 14, in a preferred embodiment, will not force a connection to Internet 16. Rather, if there is no “online” connection, the user of client system 14 will have access to coupons in an “offline” mode of operation. Thus, if the answer to step 112 is “NO”, then the method branches to step 110. Otherwise, when the answer step 112 is “YES”, then the method branches to step 114.

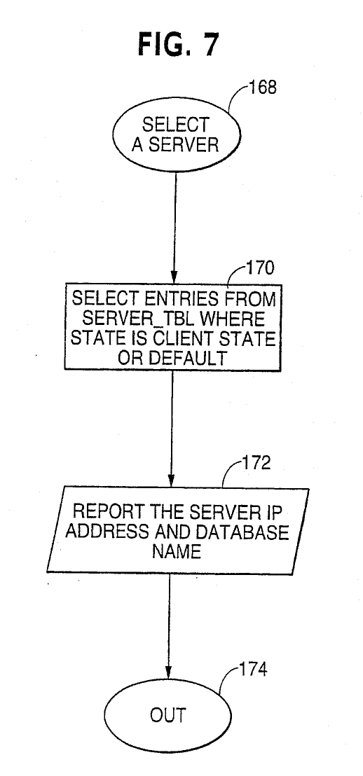

In step 114, main system 12 identifies the remote client system 14 based on a user ID 30 provided by client system 14. In this way, main server system 12 can utilize the information “on file”, such as state and zip code, for a variety of purposes. In a constructed embodiment, the state and zip code data are included in a request by front-end 20 to database server 24 to select a server that will service this user for this session (described in detail in connection with FIG. 7). The response to the request is a virtual IP address to a particular handler 22, and a selected database “name” of a selected database server 24.

In step 116, server system 12, particularly the assigned handler 22 and server 24, is updated with any information contained in user history file 34 that has not yet been uploaded and processed. The user history file contains information indicative of actions taken by, or, events occurring in response to actions taken by, the user of remote client system 14. As described above, the user history file 34 contains information such as the identity of coupons selected, coupons printed, advertising impressions displayed in advertising pane 72, etc. The assigned handler 22 in conjunction with server 24 uses the user history file in at least two ways: (i) to produce data from which a user script can be built by the remote client system 14 and, (ii) to update the user transaction database 60, which may then be queried to prepare reports that will be provided as feedback to the various advertising sponsors, coupon issuers, and coupon referral agents.

Step 118 involves obtaining a client script for execution by client system 14. Step 118 includes the substep of identifying coupons at the main server system 12 suitable for the user. What is suitable for any particular user may be based the user ID, the user information associated with the user ID, the main coupon categories selected by the user, the OS platform (e.g., MAC OS vs. Windows), the version of application 28, the cobrand ID, and the promotional code, if any. Use of these criteria can be either inclusive or exclusive. Client system 14 may be sent lists of undownloaded coupons, undownloaded ads, etc. The lists may only identify, for example, the coupons to be downloaded (not the coupon itself). Steps 120, 122, and 124 involve obtaining the actual coupon data, ad data, etc.

In step 120, the master category list, plugins, and brand logo information is updated, based on execution of the client script by client system 14. Particularly, client system 14 works through the list of needed items.

In step 122, advertising data comprising advertising impressions from advertising database 52 are updated at the remote client system 14. This step ensures that the user has the most up-to-date advertising available. Again, client system 14 works through a list of needed ads, sequentially making requests from database server 24.

In step 124, coupon data from coupon database 50 is updated at remote client system 14. Updating of the coupon data includes retrieving coupon data corresponding to the identified electronic coupons (i.e., the list provided as part of the client script).

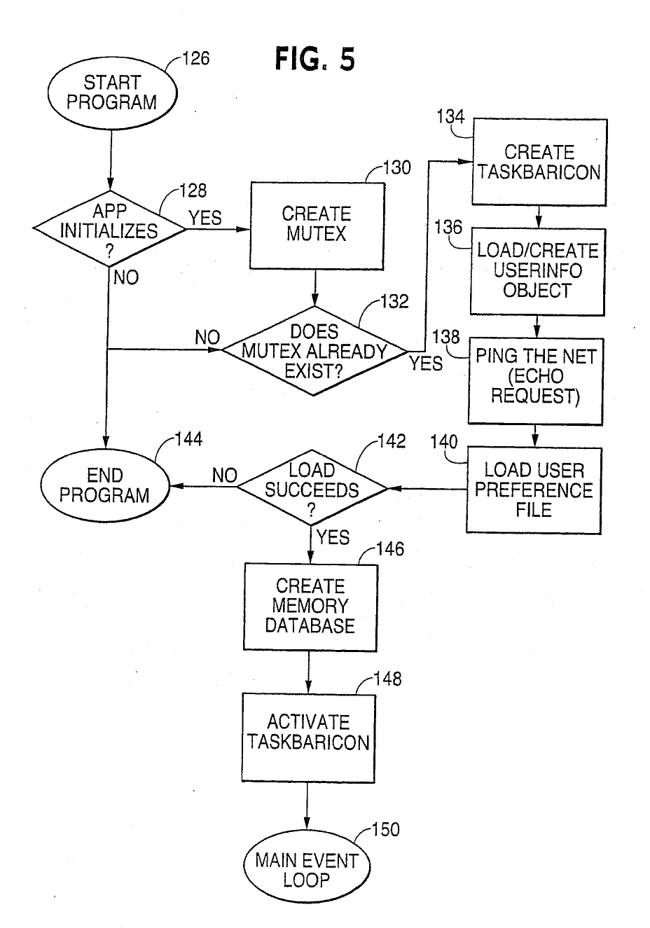

FIG. 5 shows steps 104, 106, 107 and 112 of FIG. 4 in greater detail. The method begins in step 126 with initiation of client application 28. In step 128, if client application 28 properly initializes, then the method branches to step 130. Otherwise, the method branches to step 144 where execution of client application 28 ends.

In step 130, a “mutex” is created by client application 28. “Mutex” stands for “mutually exclusive.” Programs or code segments that establish a mutex prevent other programs or code segments from running if they try to establish a mutex with the same ID. Client application 28 employs mutex functionality in the Microsoft Operating system to ensure that only one instance of application 28 is running on any given client system 14. A second instance would be denied use of the mutex, and that instance would then exit.

In step 132, a test is performed to determine whether the mutex already exists. If the answer is “NO”, the method branches to step 144 where client application 28 ends. However, if the response to the inquiry in step 132 is “YES”, then the method branches to step 134.

In step 134, taskbar icon 102 is created by client application 28. The taskbar icon 102 is graphically illustrated in FIG. 3B. As described above, a quasi-flashing taskbar icon 102, in a preferred embodiment, is a visual alert to the user of client system 14 that new coupons or offers are available for browsing. The method then proceeds to step 136.

In step 136, a UserInfo object is loaded (if it already exists) or created (if it does not already exist). If this is the first time the client application 28 has been executed, the UserInfo object must be created. As described above, the UserInfo object includes user ID 30, demographic data, proxy server information, if any and software version number. This information may be stored, for example, on a hard drive portion of client system 14. The method then proceeds to step 138.

In step 138, client system 14 transmits an echo request to main server system 12, which is received by front-end server 20. Inasmuch as client system 14 may be connected to the Internet in a variety of logically and physically different configurations (e.g., dial-up connection, proxy server, hidden proxy server such as in the case of AOL, etc.), step 138 is provided to ensure a virtual channel for messaging between client system 14 and main server system 12. The method then proceeds to step 140.

In step 140, a user preference file containing user preference data 32 is loaded into the memory of client system 14 for use by client application 28. Initially, a default set of information is used, in which all coupon categories are selected and the refresh interval is set to 4 hours. The method then proceeds to step 142.

In step 142, a test is made by application 28 to determine whether the user preference file has loaded successfully. If the answer to this inquiry is “NO”, then the method branches to step 144 (“end program”). This may occur when the user preference file has been deleted, for example. On the other hand, if the answer to step 142 is “YES”, then the method branches to step 146.

In step 146, a memory database is created for maintaining user history events. This database is configured to contain the user actions taken by the user, ad impression displayed, etc., and to store the same for later transmittal to main server system 12 as user history file 34.

In step 148, taskbar icon 102 (FIG. 33) is activated. This provides a visual cue to the user that client application 28 is available, and, that coupon lists may be browsed, coupons selected and printed out, or any other function available on client application 28. Under certain circumstances, icon 102 alerts the user to new coupons or offers.

In step 150, client application 28 begins main event loop processing. In main event loop processing, certain action, such as, for example, selecting a main coupon category, selecting a coupon subcategory, selecting a particular coupon, displaying a coupon, printing a coupon, refreshing the local coupon database, etc., may be initiated by the user and detected and executed by client application 28. While the program in accordance with the present invention may be invoked manually by user of client system 14, many operating systems, notably Windows 95/98, allow the user to specify that the execution of client application 28 should occur on startup of the computer on which client system 14 resides. Accordingly, without any further intervention by the user, upon each startup of client system 14, client application 28 will initialize.

FIG. 6 shows step 138 of FIG. 5 (the “echo request” or “ping the net” step) in greater detail. Execution of the method begins in step 152 wherein the “ping thread” portion of client application 28 commences execution.

If client system 14 is not “online”, application 28 will not force an Internet connection. Thus, in step 154, client application 28 suspends the “AutoDial” setting in the Windows registry. This ensures that the echo request to front-end server 20 does not automatically cause a dialog window to be presented to the user asking for ISP Identification and Password information.

In step 156, client system 14 through execution of client application 28, transmits a request to front-end server 20 to echo. The nature of the requested “echo” may simply be a return transmittal of an acknowledgement from front-end server 20.

In step 158, the “AutoDial” setting is restored in the Windows registry.

In step 160, the ping thread performs a test to determine whether the requested “echo” was received by way of a return transmission from front-end server 20. If the answer to this inquiry is “YES”, then the method branches to step 162, wherein a positive indication that an echo response to the echo request was returned to the client system (“DB_PINGOK”) is generated. The positive indication is provided to client application software 28 (particularly, a database thread portion thereof).

Otherwise, if no echo was received from front-end server 20, then a negative indication (“DB_NOPING”) is sent to the database thread in step 164. In either case, control from steps 162 and 164 both proceed to step 166, which is an exit step from the ping thread portion of client application 28.

FIG. 7 shows in detail the steps performed by main server system 12, particularly front-end server 20, in requesting that an appropriate handler 22 and database server 24 be selected for servicing client system 14. This “server select” operation occurs immediately after a successful “echo request” operation (FIG. 6) A plurality of database servers 24 are preferably deployed, the particular number of which is selected to match the quantity of incoming requests (“load”) from the multiplicity of client systems 14 installed remotely. Step 168 marks the beginning of the method. At this point, server system 12 has in its possession at least the demographic information previously collected (e.g., state and zip code) even if it's a “new user” with no assigned user ID yet. The database server receives the request. The method then proceeds to step 170.

In step 170, a database server 24 routine selects entries from a server table where the state in the table matches the state of residence provided by client system 14. The table entry information defines the logical entities that will service this client system 14.

In step 172, an Internet Protocol (IP) address and a database name are reported over Internet 16 to client system 14. Subsequent requests during this session from client system 14 regarding requests for updated data and the like will be sent in a message addressed to the selected server IP address (which points to a handler 22), and will include in that message the selected database name, which logically maps to entries selected in step 170 (e.g., these may be various ad databases 52, coupon databases 50, etc.). The selected IP address, in-effect, is a virtual IP address since there are a plurality of database servers 24, perhaps arranged in a cluster, that are physically provided in order to provide the desired load carrying capacity. The routing function is performed on server system 12, by handler 22 in a manner known to those of ordinary skill in the art. Such routing software and/or hardware may comprise conventional apparatus known to those of ordinary skill in the art. The method ends in step 174.

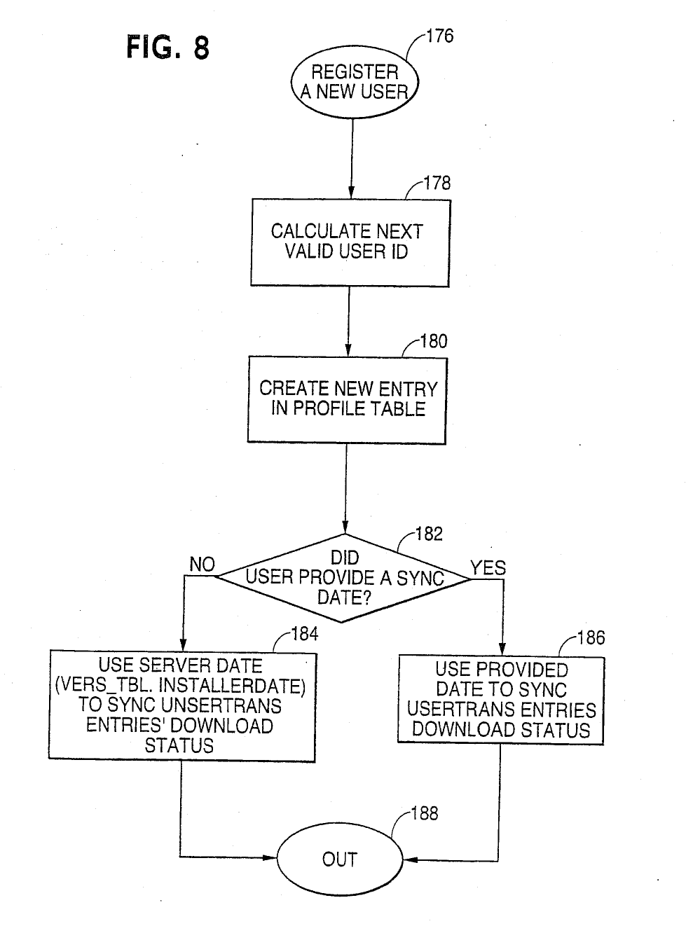

FIG. 8 shows the steps performed on main server system 12 to register a new user. The process begins in step 176 with commencement of the registration routine. In step 178, a new user ID is calculated by database server 24.

In step 180, a new entry or record is created in a user profile table. The profile entry will associate the user ID with the user information collected from the user. The method then proceeds to step 182.

In step 182, database server 24 determines whether a “sync date” was provided from client system 14. This is a date that describes how “up-to-date” client system 14 is, particularly the coupon and advertising information portions thereof. The use of the sync date has been described above in connection with FIG. 4. This “sync date” is automatically provided from client system 14 to database server 24 via the assigned handler 22. If a “sync date” was not provided by client system 14, then the method branches to step 184 where a nominal sync date based on the version of the software installed on the client system is used for downloading and updating purposes. Alternatively, if the answer to step 182 is “YES”, then the method branches to step 186.

In step 186, the date provided by client system 14 is used as the “sync date” to synchronize the data on client system 14 relative to the master data on main server system 12. It should be emphasized that the “sync date” is not a date that client application 28 solicits from the user, but rather, is simply a date available within client application 28 relating to the how “current” the data is (i.e., coupon/advertising data, etc.). In either case, the method proceeds to and ends at step 188.

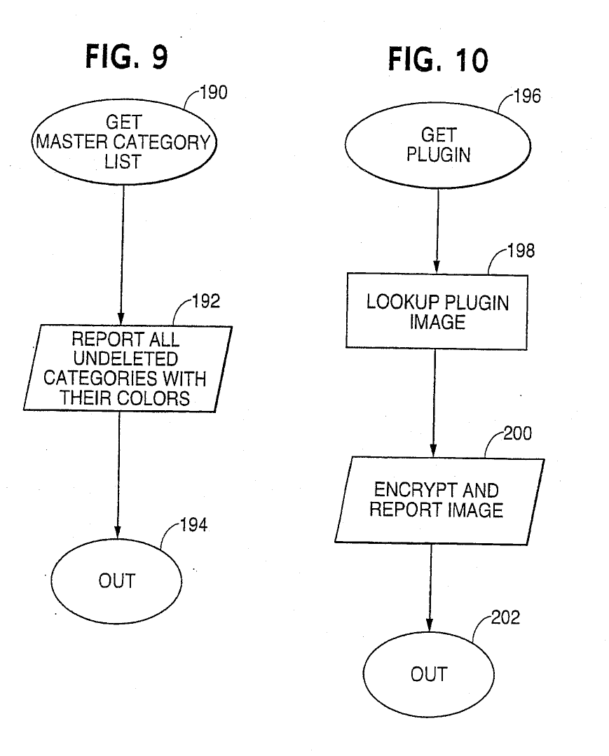

FIGS. 9, 10 and 11 show step 120 (FIG. 4) in greater detail. Referring to FIG. 9, step 190 represents a request to obtain a master category list (i.e., the up-to-date list). This request is made from client system 14 to the selected database server 24 via handler 22. Such a request is directed to the selected “virtual” IP address as described above. The master coupon category list (e.g., “Athletics”, “Automotive”, “Internet Electronics”, etc.) may be updated on main server system 12, particularly database server 24. That is, categories may be added, and/or categories may be deleted. In either case, such a change will be reflected in interface 62 of the respective client systems 14 when the next session is invoked by a user.

In step 192, all undeleted master coupon categories, along with their display color (as displayed on display 40 of client system 14) are reported out to client system 14 for use by client application software 28. Step 194 ends the master coupon category list updating process.

Referring now to FIG. 10, step 196 represents a request from client system 14 to database server 24 via handler 22 to obtain a new or an up-to-date plugin(s). It should be understood that for an existing user, client system 14 may be executing a client script that includes a list containing needed plugins. The process outlined in FIG. 10 would be executed for each plugin on the list.

In step 198, database server 24 performs a look-up of the needed plugin to locate the corresponding plugin file (or image).

In step 200, an “image” or copy of the file of the sought-after plugin is encrypted in accordance with a server system encryption strategy, and is reported or transmitted via Internet 16 to client system 14. In step 202, the plugin update process is completed.

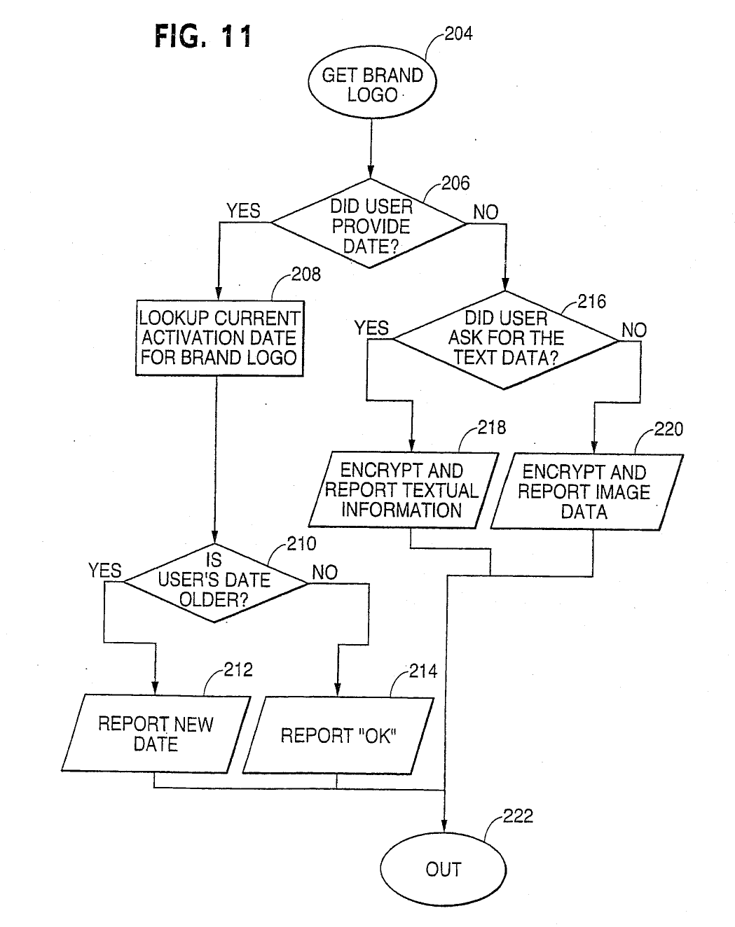

Referring now to FIG. 11, steps 204-222 illustrate the steps involved in determining whether to maintain a default brand logo in logo pane 74 (FIG. 3A), or, in the alternative, whether to download a different brand logo. While a default brand or company logo is associated with client system 14 initially, the default may be changed. For example, a user of Internet 16 may be informed of the existence of electronic coupon distribution system 10 by a third-party vendor who also maintains a website, and refers that Internet user to website server 18 of main server system 12. The referral mechanism, a hyperlink or the like to website server 18, appends the identification of the referring vendor to the HTTP reference (the ID herein referred to as the “cobrand ID”). Website server 18 is configured to recognize and respond to such appended data (the cobrand ID) by putting a “cookie” (i.e., a file used by Internet browser programs) on such Internet user's computer system that contains the cobrand ID. Then, if such potential user of system 10 decides to download and install the client software, the client installation software will search for the “cookie”. If it finds the “cookie”, and certain other qualifying criteria are satisfied, then the cobrand ID will be passed to server 12 upon installation with a request to download the text or image data of the other (non-default) brand logo.

Some client systems 14 will be deployed with both a default brand logo, and an alternate brand logo (including text/images), in alternative embodiments. The following steps apply when client application 28 determines that it should display an alternate brand logo.

In step 204, client system 14 requests a brand logo (non-default). The process proceeds to step 206.

In step 206, database server 24 determines whether client system 14 provided a date along with the request for the alternate brand logo. If so, then client system 14 already has the text/images corresponding to the brand logo and just needs to determine whether to turn the requested brand logo “on” at the client system 14.

Thus, if the answer to step 206 is “YES”, then the method branches to step 208. In step 208, database server 24 conducts a look-up to determine an activation date for the subject brand logo. The method then proceeds to step 210.

In step 210, database server 24 determines whether the client-provided date is “older” than the current activation date. If “YES”, then the method branches to step 212, where the new activation date is reported out to the client system 14. The client system 14 will therefore defer activation of the alternate, non-default brand logo until such new date. Otherwise, the method branches to step 214, where the database server 214 reports an “ok” to client system 14. Client system 14 will then implement (i.e., display) the brand logo corresponding to the cobrand ID.

When the method branches to step 216, (a “NO” to step 206), database server 24 performs another test to determine whether client system 14 asked for text corresponding to the cobrand ID. If “YES”, then the method branches to step 218, where the textual information is encrypted according to a server system encryption strategy, and reported out to client system 14. Otherwise, step 220 is performed, where image data corresponding to the cobrand ID is encrypted (according to a server system encryption strategy), and reported to client system 14. The method ends in step 222.

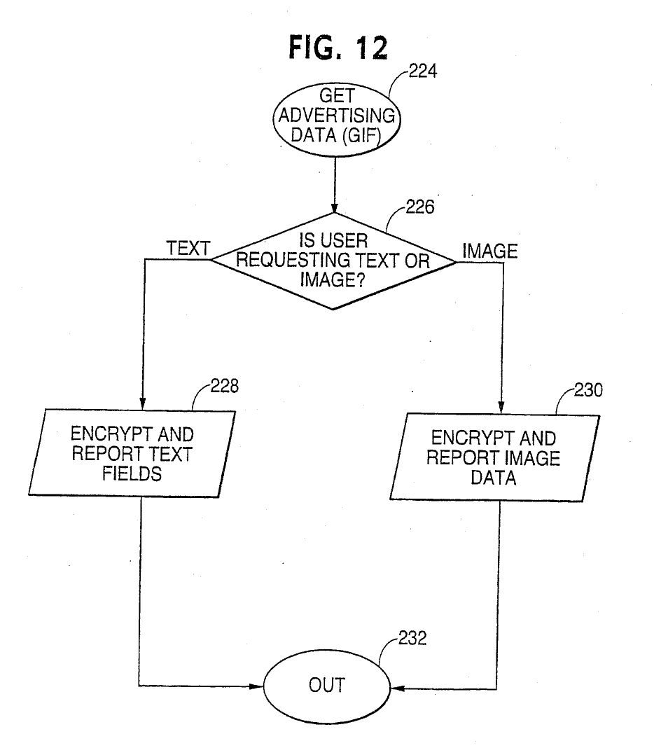

FIG. 12 shows step 122 (“updating advertising data”) of FIG. 4 in greater detail. In particular, steps 224-232 illustrate, in accordance with the present invention, that advertising text, and images are encrypted to thereby provide secure transmission to client system 14. It should be understood that for an existing user, client system 14 may be executing a client script that includes a list containing needed advertising impressions. The process outlined in FIG. 12 would be executed for each advertising impression on the list. Step 224 marks the beginning of the advertising update method.

In step 226, main server system 12 determines whether the user, more particularly client system 14, is requesting “text” or “image” advertising data. If the answer is “text”, then the method proceeds to step 228.

In step 228, main server system 12, particularly database server 24, encrypts the text of the advertising data, and reports out the resulting encrypted advertising data. It should be understood this encryption occurs in accordance with a server system encryption strategy.

Otherwise, the method proceeds to step 230 when the advertising data requested is “image” data. In step 230, the advertising data (“image” data) is encrypted by main server system 12 according to a main server system encryption strategy, resulting in encrypted advertising image data. The encrypted ad image data is then reported out to client system 14.

Step 232 defines the end of the advertising update process.

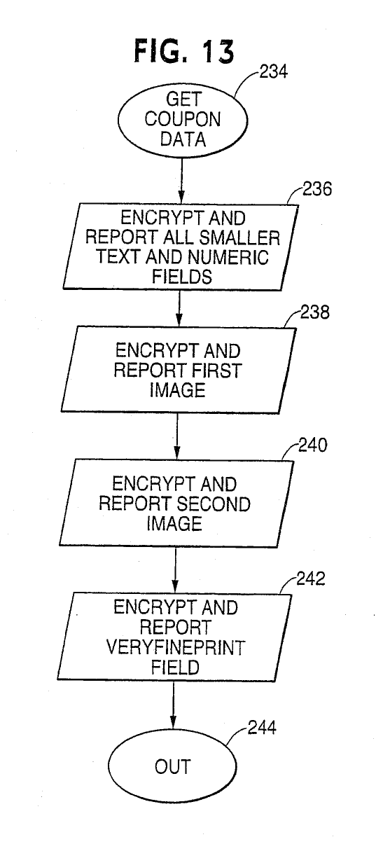

FIG. 13 illustrates, in greater detail, step 124 in FIG. 4 (“updating coupon data”). It should be understood that for an existing user, client system 14 may be executing a client script that includes a list containing needed coupon data. The process outlined in FIG. 13 would be executed for each electronic coupon on the list.

Steps 234-244 illustrate that coupon text and image data are encrypted in accordance with a server system encryption strategy prior to transmission to client system 14, resulting in encrypted coupon data. It bears emphasizing that the steps 234-244 in FIG. 13, occur at main server system 12. Since the coupon data is encrypted, even if intercepted, the actual coupons cannot be easily recovered and reprinted. This reduces the occurrence of fraud.

In step 234, client system 14 issues a request to get a particular electronic coupon. In step 236, database server 24 encrypts and reports (to client system 14) all smaller text and numeric fields. In steps 238 and 240, database server 24 encrypts and reports, respectively, first and second images associated with the requested electronic coupon. In step 242, the very fine print portions of the requested e-coupon in encrypted and reported out to client system 14. Step 244 is an exit step.

FIG. 14 shows, in greater detail, step 116 of FIG. 4 (“transmitting to the server system user history information”) Steps 246-264 occur principally on main server system 12, more particularly, between handler server 22 and database server(s) 24. Prior to step 246, client system 14 sends a message to database server 24 containing the user history file 34. Step 246 marks the beginning of the process-used by main-server system 12 in recording the events contained in the user history file 34.

In step 248, the user and server information is extracted from the user history file 34. This information is used in updating the user transaction records associated with the identified user of electronic coupon distribution system 10. The information developed in this process is also used to generate a client script that will be described in further detail.

In step 250, a test is made to determine whether there is any user and server information in the user history file. If the answer to this inquiry is “NONE”, then flow of the process proceeds to step 252 where an indictor “NO GOOD” is reported out. Flow of the process then continues to step 254 where the process exits.

On the other hand, if user and server information is successfully extracted from the user history file, flow of the process continues at step 256. In step 256, a “WHILE DO” process structure is established. Method steps 256, 260, 262, and 264 are continuously repeated while there are new history codes remaining to be read-out and extracted from the user history file 34.

In step 260, the next history code is extracted along with any arguments pertaining thereto. Flow of the process then proceeds to step 262, and 264 where the extracted user history codes are decoded. For example, a user history code designated “F” indicates that coupon entries should be synchronized, for this user to the date so provided as the argument (i.e., to the so-called “sync date”) This is shown in block 264₉. As another example, a user history code “B”, specifies that an advertising impression described in the argument should be recorded in a user transaction record. This is shown in block 264₁₃. The ad impression, when recorded, may be used thereafter to prepare reports for the sponsor of the advertising impression. Other user history codes involve modification of a user transaction entry. For example, the code “N” indicates a positive confirmation by client system 14 that certain coupons were downloaded successfully. Accordingly, the user transaction entry should be edited to so indicate. In this way, positive feedback is provided as to what coupons have been safely received at the remote client system 14. FIG. 14 specifically identifies thirteen codes, and corresponding responses, respectively designated 264₁-264₁₃.

When the last remaining history code has been extracted and decoded, the “WHILE DO” loop at step 256 fails, and flow of the process proceeds to step 258. In step 258, the database server 24 reports an “Okay” message to handler 22. Flow of the process then proceeds to an exit step, designated step 254.

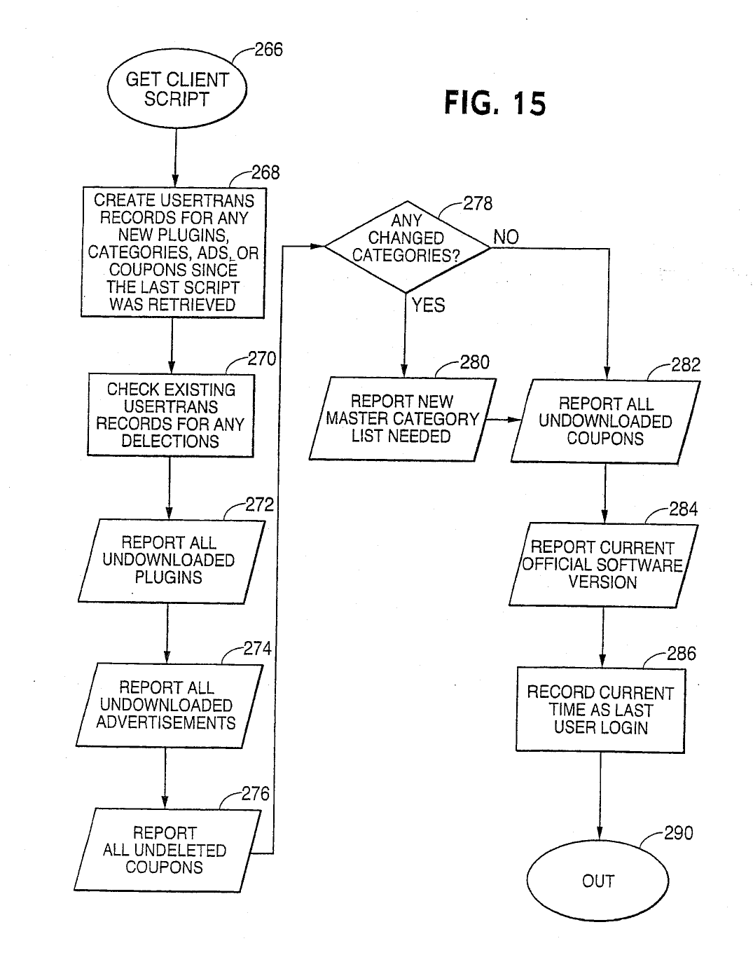

Referring now to FIG. 15, after the user history codes from the user history file 34 have been extracted and decoded, a “client script” is built by client system 14 based on information (e.g., lists) from handler 22 in cooperation with database server 24. The client script provides instructions for system 14 to execute.

In step 266, client system 14 issues a request to handler 22 to obtain the “user” or “client” script. The client script is then returned to client system 14. Step 268 show the execution of the client script by client system 14, which issues the commands shown in the steps 268-290.

In step 268, client system 14 issues commands via handler 22 to database server 24 to create user transaction records for any new plugins, main coupon categories, advertising data, or coupon data received by client system 14 since the last client script was retrieved.

In step 270, client system 14 issues commands via handler 22 to database server 24 to check existing user transaction records for any deletions. Any deletions are processed whereby the affected user transaction record will be modified to indicate that the client coupon has been deleted.

In step 272, client system 14, in execution of the client script, issues a command via handler 22 to database server 24 to report all undownloaded plugins. Database server 24, through handler 22, returns a message containing a listing of all undownloaded plugins. This list will be processed by client system after the client script has been completed.

In step 274, client system 14, in execution of the client script, issues a command via handler 22 to database server 24 to report all undownloaded advertising impressions. Database server 24 returns a list of all undownloaded ad impressions.

In step 276, client system 14, in execution of the client script, issues a command via handler 22 to database server 24 to report all undeleted coupons.

In step 278, client system 14, in execution of the client script, issues a command via handler 22 to database server 24 to determine whether any of the main coupon categories have been changed. If the answer to this inquiry is “YES”, then flow of the process continues at step 280, wherein the database server 24 reports to client system 14 that a new master category list is needed. Flow then proceeds to step 282.

If the answer to the inquiry in step 278 is “NO”, then flow of the process proceeds to step 282. In step 282, client system 14, in execution of the client script, issues a command via handler 22 to database server 24 to report all undownloaded electronic coupons. Database server 24 returns a listing of all undownloaded coupons.

In step 284, client system 14, in execution of the client script, issues a command via handler 22 to database server 24 to report the current official software version. Database server 24 returns the latest version number.

In step 286, database server 24 is requested to record the current time as the last user login. Flow of the process then continues to step 290, which marks the end of the client script execution.

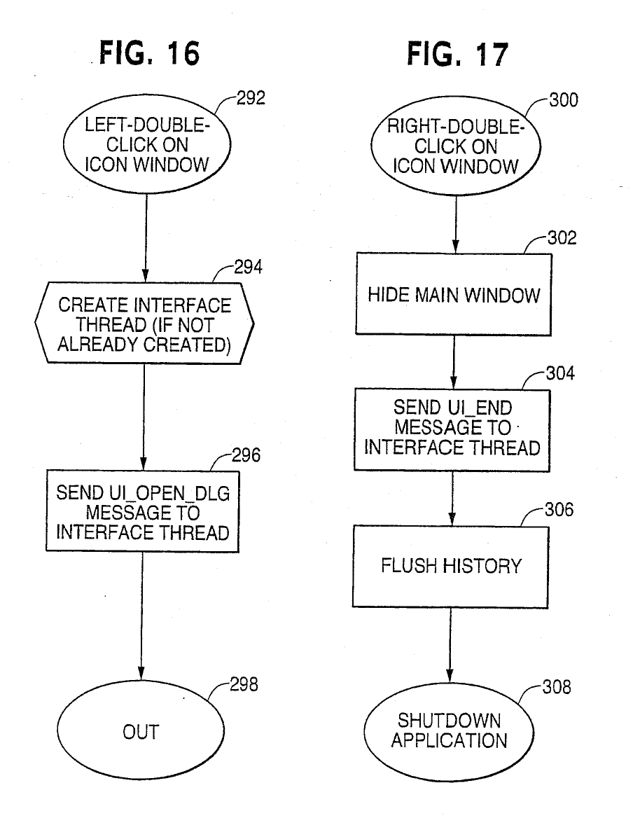

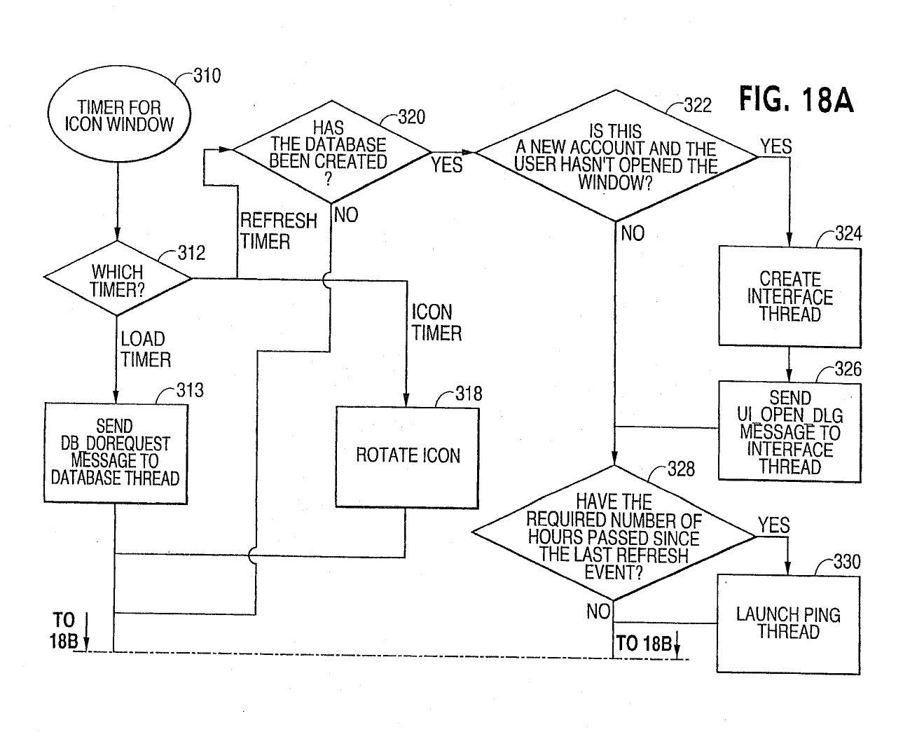

Referring now to FIGS. 16 and 17, upon initial execution of client application 28, a taskbar icon 102 is created, as illustrated in FIG. 3B. Referring particularly now to FIG. 16, steps 292-298 illustrate the steps that client application 28 performs when the taskbar icon 102 is left double clicked. Step 292 marks the beginning of the process that initiates the display of user interface 62. Step 292 is performed when it is detected that the user has left-double-clicked on taskbar icon 102.

In step 294, application 28 creates an interface thread, unless interface 62 has already been created by a preexisting interface thread.

In step 296, a user interface open dialog message is sent to interface thread by client application 28. The result of the execution of steps 294, and 296 results in the display shown in FIG. 3A.

In step 298, the process that creates interface 62 via an interface thread exits.

Referring now particularly to FIG. 17, in step 300, main client application 28 determines (via the OS, for example) when taskbar icon 102 has been right double clicked and enters the process of steps 300-308.

In step 302, the “window” in which main user interface 62 would generally be displayed is hidden from the user (i.e., disappears from the display as viewed on display 40 of client system 14).

In step 304, client application 28 sends a user interface-end message to the interface thread portion of client application 28.

In step 306, client application 28 flushes the history (i.e., any unsaved user history actions or events are encrypted and written to the user history file).

In step 308, client application 28 shuts down This removes the application 28 from client system 14.

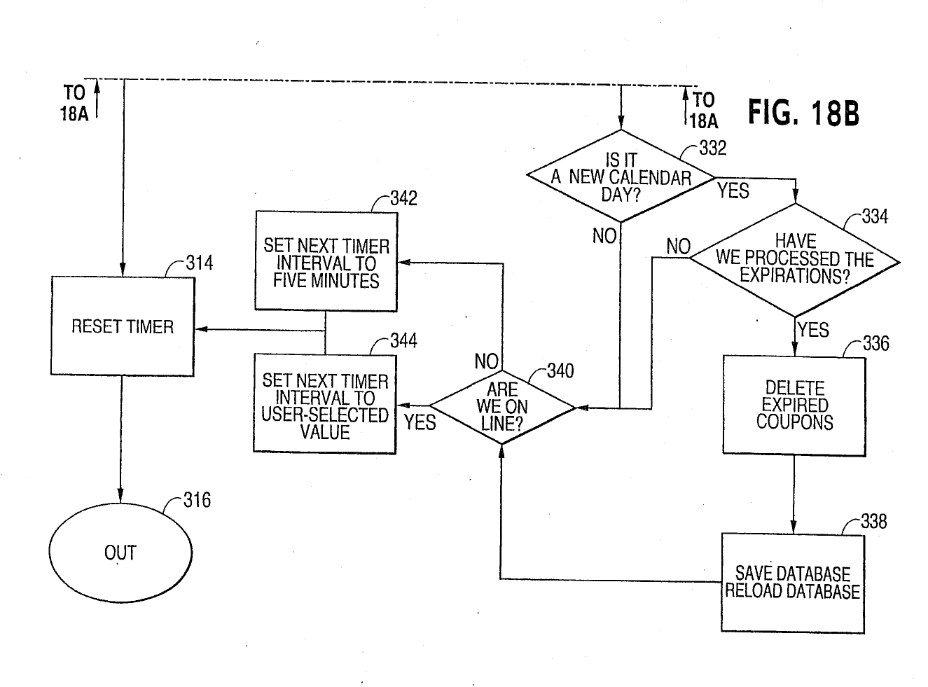

FIG. 18 illustrates a portion of the timing loops executing on main client application software 28.

The flow chart illustrates the operation of three timers: the “load” timer, the “icon” timer, and the “refresh” timer. The steps in FIG. 18 may hereafter be referred to as the timing loop thread. Step 310 marks the beginning of the processing for evaluating the various timing loops illustrated in FIG. 18.

In step 312, a decision is made by application 28 as to which timer is being evaluated. If the “load” timer is being evaluated in the timing loop thread illustrated in FIG. 18, then flow of the process continues at step 313. In step 313, the timing loop thread sends a message to the database thread. In particular, the DB_DOREQUEST is the event the database thread uses to perform the delayed downloading. The client system 14 feeds a DB_DOREQUEST event to the database thread while there are any coupons, plugins, or ad impressions remaining to download. In response to this event, the database thread pops the top download request off the download queue and retrieves that item.

Flow of the process then proceeds to step 314, wherein the “load” timer is reset. Flow of the process then proceeds to step 316, where the timing loop thread exits.

On the other hand, if the timer being evaluated is the “icon” timer, as determined in step 312, then flow of the process proceeds to step 318. In step 318, the client application 28 rotates taskbar icon 102. This is done only when there are new coupons or offers available to the user on coupon distribution system 10. That is, this is the loop that causes the taskbar icon 102 to change display states so as to present a “flashing” effect to alert the user to the availability of new coupons and/or offers. The flow of the process then proceeds through steps 314-316, wherein the “icon” timer is reset and the timing loop thread is exited.

Finally, if the timer being evaluated in the timing loop thread is the “refresh” timer, as determined in step 312, then flow of the process proceeds to step 320. In step 320, the timing loop determines whether the coupon database has been created If the answer is “NO” then the process proceeds through steps 314-316, where the refresh timer is reset, and the timing loop is exited.

On the other hand, if the answer to the inquiry in step 320 is “YES”, then flow of the process proceeds to step 322. In step 322, if a user hasn't opened the user interface window containing interface 62 (FIG. 3A), and, the account is a new account, then flow of the process proceeds to step 324, wherein the “create interface” thread is invoked to create user interface 62 (best shown in FIG. 3A). The process then proceeds to step 326, wherein a user interface open dialog message is sent to the interface thread, which displays the user interface 62 in a window. Flow then proceeds to step 328. If the answer to the inquiry in step 322 is “NO”, then flow of the process also proceeds to step 328.

In step 328, the timing loop determines whether the predetermined, number of hours has passed since the last refresh event. In accordance with the invention, the user may select, as described above, from a number of different refresh intervals (e.g., one-hour, two-hours, etc.). The value of this parameter is what is being tested in step 328. If the answer to this inquiry is “YES”, then the process branches to step 330, where the echo-request/ping-the-net thread is invoked (FIG. 6). If the answer to step 328 is “NO”, then the process branches to step 332.

In step 332, the timing loop thread determines whether the present day is a new calendar day. This parameter needs to be tested because some coupons may now be “expired” that were not “expired” on the prior calendar day. If the answer to this inquiry is “YES”, then the process branches to step 334. In step 334, the timing loop thread determines whether client application 28 has processed the coupon expirations arising because of the new calendar day. If the answer to this inquiry is “YES”, then the process branches to steps 336, and 338, where expired coupons are deleted from the database (memory), the database is saved (file), and the database is thereafter reloaded into the memory of the client application 28. The method proceeds to step 340.

If the answer to the inquiry in steps 332 or 334 is “NO” then the method branches to step 340. In step 340, the timing loop thread determines whether client system 14 is “online”. It may make this determination based on the response from the “ping” thread, invoked in step 330. If the answer to this inquiry is “NO”, then the process branches to step 342. In step 342, the next timer interval is set to five minutes (i.e., try again in five minutes to see if the user is “online”). According to the invention, application 28 will not force the user to connect to Internet 16 to refresh the client system, but will simply wait a preselected time (e.g., five minutes) and check again to see if the user's connected.

Otherwise, if the answer to step 340 is “YES”, then the process branches to step 344, in which the next timer interval is set to the user-selected value (i.e., the one hour, two hour, etc. that the user chooses as the selected refresh interval).

Flow then proceeds from both steps 342 and 344 to step 314 where the “refresh” timer is reset. The process exits in step 316.

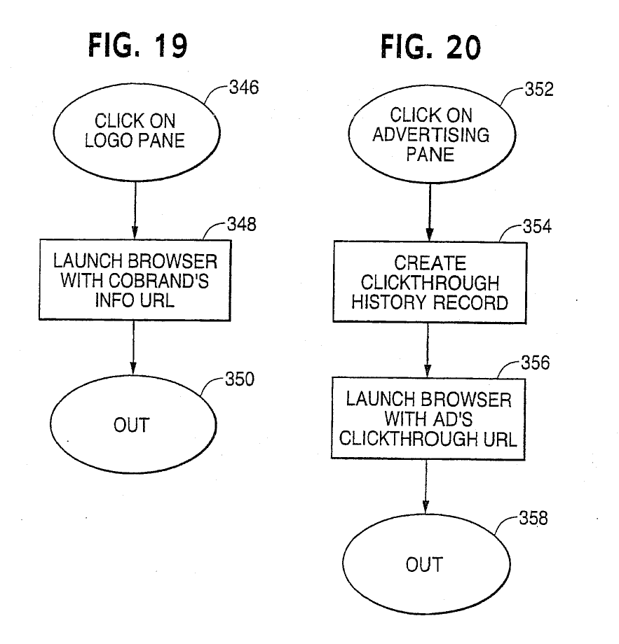

In FIG. 19, steps 346-350 illustrate the response of client application 28 when a user “clicks” or otherwise selects the logo pane 74 of user interface 62 (best shown in FIG. 3A). Step 346 marks the beginning of the routine. Step 346 is entered when application 28 (via the OS) detects that the user has “clicked” on or otherwise selected a portion of logo pane 346.

In step 348, the client application 28 invokes an Internet browser registered with the operating system of client system 14 as the default browser and passes thereto a URL. The Internet browser then connects to a website server resource corresponding to the specified URL. This “click” action, therefore, takes the user to the website of the company displayed in the logo pane 74. Step 350 marks the end of this routine.

FIG. 20 shows the response of client application 28 when a user “clicks” on or otherwise selects a portion of advertising pane 72 (best shown in FIG. 3A). Step 352 marks the beginning of the routine.

In step 354, client application 14 creates a click-through history record indicative of the fact that the user has “clicked” or otherwise selected the advertiser displayed in the advertising pane 72. This will be included in the user history file 34, which will thereafter be encrypted and transmitted to main server system 12 for processing.

In step 356, the client application 28 launches an Internet browser registered with the operating system of client system 14, and passes thereto a URL corresponding to the advertiser displayed in advertising pane 72. When the Internet browser executes, it connects to a website server resource defined by the URL. In-effect, the foregoing actions take the user to the advertiser's website specified in the URL.

Step 358 marks the end of this routine.

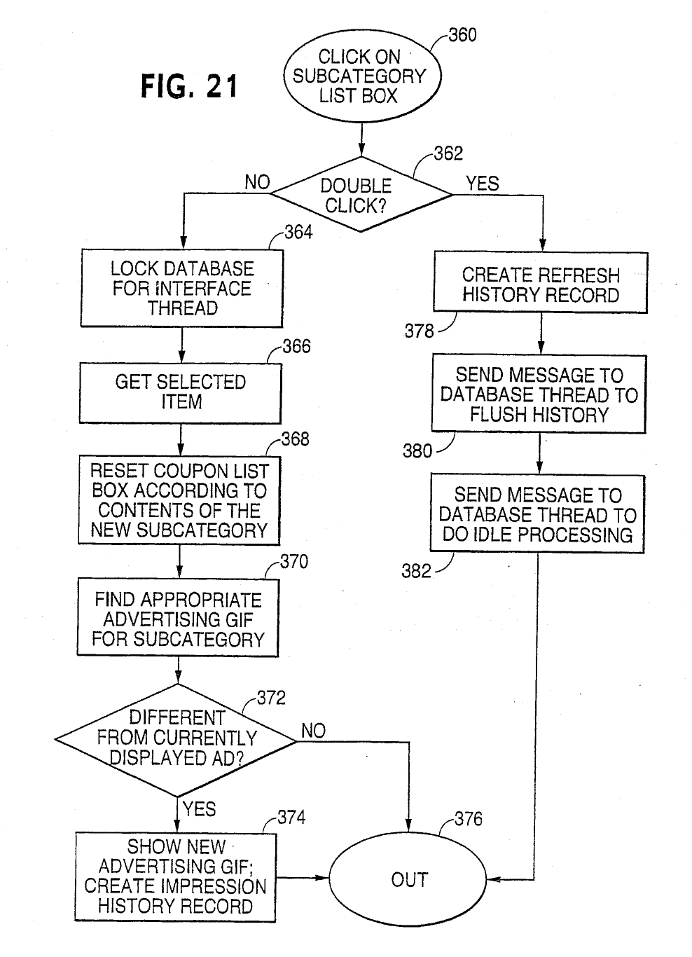

FIG. 21 illustrates a response taken by client application 28 when a user “clicks” on or otherwise selects an item appearing in the coupon subcategory list box 68 (best shown in FIG. 3A) Step 360 marks the beginning of the process. Step 360 is entered when client application 28 (via the OS) determines that an item in list 68 has been “clicked” on.

In step 362, client application 28 determines whether the selection was a “click” or a “double-click”. Depending on which of these events occurred, client application 28 will take alternative courses of action. If the action is a single-click, then the method branches to step 364. In step 364, the local coupon database is locked by application 28. The process proceeds to step 366.

In step 366, the selected subcategory item is retrieved from the local database on client system 14.

In step 368, the contents of coupon list 70 is reset by application 28 according to the contents of the new subcategory. For example, if the new subcategory pertains to coupons, then the new coupons associated with the new selected subcategory are displayed in coupon list box 70 (best shown in FIG. 3A).

In step 370, client application 28 determines or otherwise selects an advertising impression to be displayed in advertising box 72 in accordance with a predetermined advertising impression selection strategy. In the illustrated embodiment, the selection criteria includes the identity of the selected coupon subcategory.

In step 372, a test is performed by application 28 to determine whether the newly selected advertising impression is different from the advertising impression currently being displayed. If the answer is “YES”, then the process branches to step 374, where the new advertising impression is displayed in advertising box 72, and an advertising impression history record is created for inclusion in the user history file 34. The method proceeds to step 376, which exits the thread shown in FIG. 21. If the answer to step 372 is “NO”, however, then the process branches to step 376, which is an exit step.

If the action evaluated in step 362 is determined to be a “double click”, then the process branches to step 378. “Double clicking” a coupon subcategory is a user request to refresh the contents of that subcategory.

In step 378, client application 28 creates a refresh history event for that subcategory.

In step 380, client application 28 sends to the database thread a request to flush the current history. The contents of that subcategory are then downloaded (available on the display 40) as if they were new.

In step 382, a message is sent to the database thread to do idle processing.

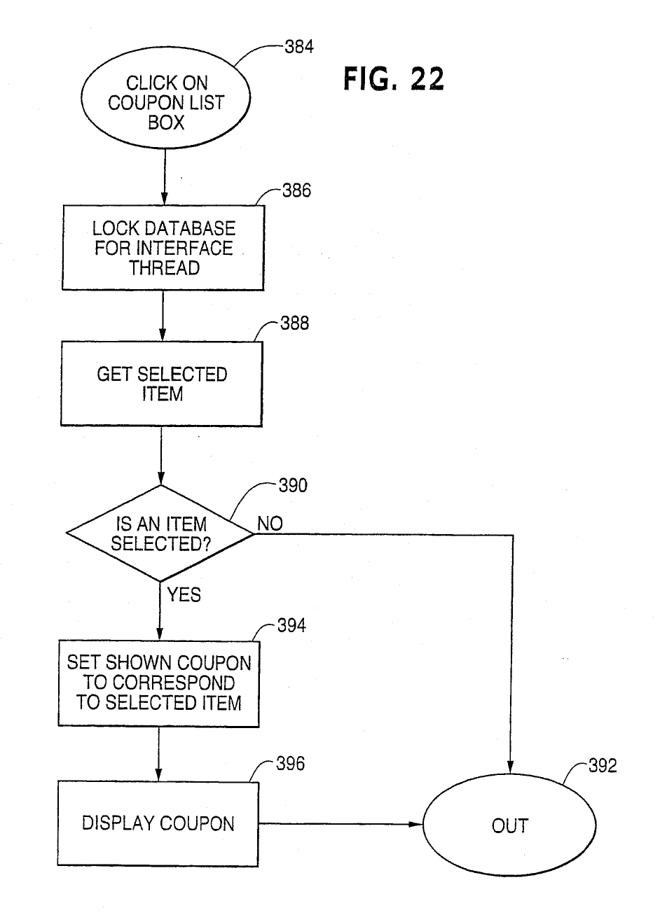

FIG. 22 illustrates the response by client application 28 when a user “clicks” on an item from coupon list box 70.

The process begins in step 384. Step 384 is entered when client application 28 detects that an item in the coupon list box 70 (VIA the OS) has been “clicked” on.

In step 386, client application 28 locks the local coupon database for the interface thread.

In step 388, client application 28 obtains from the local coupon database the item corresponding to that selected in coupon list box 70.

In step 390, client application 28 determines whether the item in the coupon list box 70 that was clicked on was actually “selected”. If the answer to this inquiry is “NO”, then the method branches to step 392, which is an exit.

If the answer to step 390 is “YES”, then the process branches to step 394.

In step 394, the client application 28 sets the shown coupon to correspond to the item selected in coupon list box 70. The process then proceeds to step 396.

In step 396, client application, by way of the interface thread, displays the coupon in the coupon display pane 76. The method then proceeds to step 392, which is an exit step.

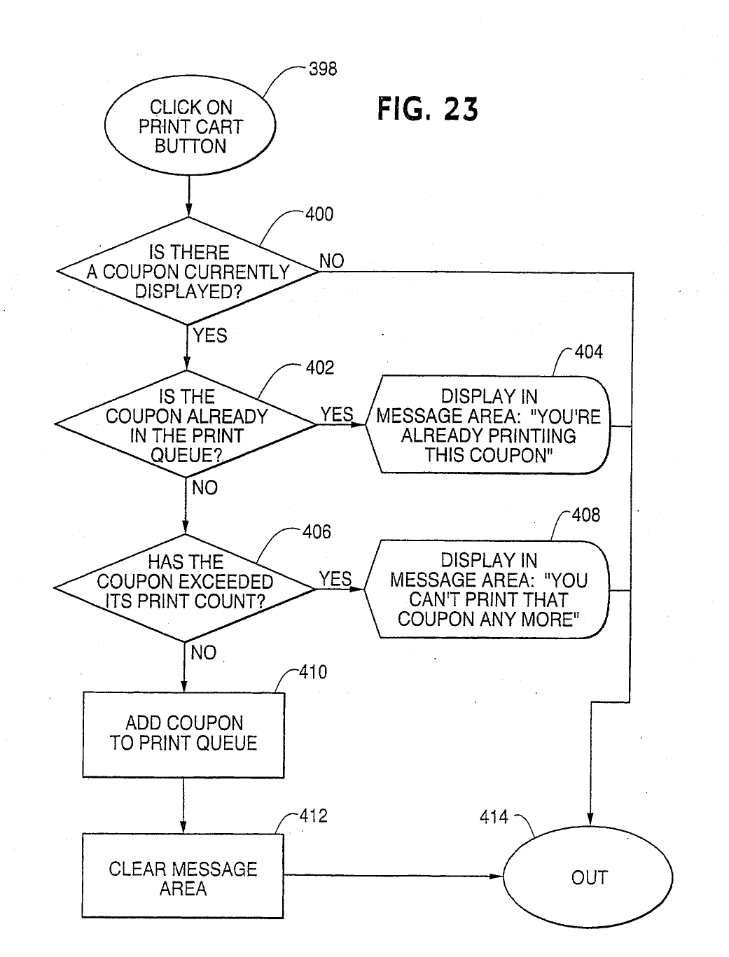

FIG. 23 illustrates the process carried out by client application 28 when the “Print Cart” button 78 is “clicked” on or otherwise selected by the user. Step 398 is invoked when client application 28 (VIA the OS) determines that the Print Cart button has been “clicked” on. The process then proceeds to step 400.

In step 400, client application 28 performs a test to determine whether there is a coupon currently displayed in coupon display pane 76. If the answer to step 400 is “NO”, then the method branches to step 414, which is an exit step.

If the answer to step 400 is “YES”, then the method branches to step 402. In step 402, client application determines whether the coupon currently being displayed in display pane 76 is already in the print queue. If the answer to this inquiry is “YES”, then the method branches to step 404. In step 404, client application 28 causes a predetermined message to be displayed in message display area 94 advising, for example, the user that the coupon is already in the print queue ready for printing. This insures that coupons are not inadvertently printed more times than the user desires. If the user in-fact wishes to make multiple hard copies of the coupon in the display pane 76, the user may alternatively click on the “Print Now” button to print more than one hard-copy version of the coupon (if permitted by the rules or instructions associated with the coupon). The process then proceeds to step 414, which is an exit step.

If the answer to step 402 is “NO”, then the method branches to step 406. In step 406, client application determines whether the proposed printing of the coupon would exceed the associated maximum print count for that coupon. If the answer to this step is “YES”, then the method branches to step 408. In step 408, an appropriate message is displayed to the user in the message display area 94, advising that no further printouts of the coupon can be made. The method then proceeds to step 414, which is an exit step.

If the answer to step 406 is “NO”, then the method branches to step 410. In step 410, the coupon currently being displayed in coupon display area 76 is added to the print queue. The method proceeds to step 412, wherein message display area 94 is cleared, thereby clearing any pre-existing message displayed therein. The process then proceeds to step 414, which is an exit step.

It is to be understood that the above description is merely exemplary rather than limiting in nature, the invention being limited only by the appended claims. Various modifications and changes may be made thereto by one of ordinary skill in the art which embody the principles of the invention and fall within the spirit and scope thereof.

What is claimed is:

1. A method comprising:
receiving, at a computing device, coupon data indicating a coupon;
receiving, at the computing device, in association with the coupon data, distribution instructions for the coupon;
the computing device receiving input indicating a request to output the coupon;
in response to the input, the computing device determining whether the coupon may be outputted based at least on the distribution instructions;
if it is determined that the coupon may be outputted, the computing device causing one of:
a) the coupon being printed based on the coupon data; or
b) the coupon being redeemed electronically based on the coupon data.

2. The method of claim 1, further comprising, if it is determined that the coupon may be not outputted, the computing device refusing to allow printing of the coupon or electronic redemption of the coupon

3. The method of claim 1, wherein the distribution instructions includes data indicating a number of times the coupon may be outputted.

4. The method of claim 3, further comprising:
in response to each of a first two or more requests to output the coupon, the computing device determining that the coupon may be outputted based on the distribution instructions,
in response to each of a second one or more requests to output the coupon, the computing device refusing to allow printing or electronic redemption of the coupon based on the distribution instructions.

5. The method of claim 3, wherein the computing device stores data indicating the number of times the coupon has been printed or electronically redeemed, wherein determining whether the coupon may be outputted is further based on the data indicating the number of times the coupon has been printed or electronically redeemed.

6. The method of claim 1, wherein the distribution instructions include restrictions based on one or more of: a state in which a user associated with the computing device resides, a zip code in which a user associated with the computing device resides, an expiration date, an item to which the coupon is limited, and a discount amount to which the coupon is limited.

7. The method of claim 1, wherein, if it is determined that the coupon may be outputted, a) the coupon is printed based on the coupon data.

8. The method of claim 1, wherein, if it is determined that the coupon may be outputted, b) the coupon is redeemed electronically based on the coupon data.

9. The method of claim 1, wherein the distribution instructions are received in the coupon data.

10. The method of claim 1, wherein the coupon data is a data structure comprising at least one or more textual or numeric fields and one or more images, both of which specify information about the coupon.

11. A method comprising:
transmitting first instructions which, when executed by a client, cause the client to request a coupon from a server;
receiving, from the client, the request;
in response to the request, sending coupon data to the client, the coupon data indicating the requested coupon;
further in response to the request, sending, in association with the coupon data, distribution instructions indicating how the coupon is to be distributed;
wherein the first instructions, when executed by the client, further cause the client to determine whether or not to allow a user to output the coupon based on the distribution instructions;
wherein the method is performed by one or more computing devices, wherein the one or more computing devices includes the server.

12. The method of claim 11, wherein the first instructions, when executed by the client, further cause:
if it is determined that the coupon may be outputted, the client causing the coupon to be printed based on the coupon data;
if it is determined that the coupon may be not outputted, the client refusing to allow printing of the coupon.

13. The method of claim 11, wherein the first instructions, when executed by the client, further cause:
if it is determined that the coupon may be outputted, the client causing the coupon to be redeemed electronically based on the coupon data;
if it is determined that the coupon may be not outputted, the client refusing to allow electronic redemption of the coupon.

14. The method of claim 11, wherein the distribution instructions include data indicating a number of times the coupon may be outputted.

15. The method of claim 14, wherein the first instructions, when executed by the client, further cause:
in response to each of a first two or more requests by the user to output the coupon, the client determining that the coupon may be outputted based on the distribution instructions;
in response to each of a second one or more requests by the user to output the coupon, the client refusing to allow printing or electronic redemption of the coupon based on the distribution instructions.

16. The method of claim 14, wherein the first instructions, when executed by the client, further cause the client to store data indicating the number of times the coupon has been printed or electronically redeemed, wherein determining whether the coupon may be outputted is further based on the data indicating the number of times the coupon has been printed or electronically redeemed.

17. The method of claim 11, wherein the distribution instructions include restrictions based on one or more of: a state in which a user associated with the client resides, a zip code in which a user associated with the client resides, an expiration date, an item to which the coupon is limited, and a discount amount to which the coupon is limited.

18. The method of claim 11, wherein the first instructions are instructions for a client-based software application, wherein transmitting the first instructions comprises one of: transmitting an installer for the software application to the client or transmitting the installer to a host from which it may be downloaded by the client.

19. The method of claim 11, wherein the distribution instructions are sent in the coupon data.

20. The method of claim 11, wherein the coupon data is a data structure comprising at least one or more textual or numeric fields and one or more images, both of which specify information about the coupon.

21. One or more storage media storing instructions which, when executed by one or more processors, cause performance of:
receiving, at a computing device, coupon data indicating a coupon;
receiving, at the computing device, in association with the coupon data, distribution instructions for the coupon;
the computing device receiving input indicating a request to output the coupon;
in response to the input, the computing device determining whether the coupon may be outputted based at least on the distribution instructions;
if it is determined that the coupon may be outputted, the computing device causing one of:
a) the coupon being printed based on the coupon data; or
b) the coupon being redeemed electronically based on the coupon data.

22. The one or more storage media of claim 21, wherein the one or more instructions, when executed by the one or more processors, further cause performance of, if it is determined that the coupon may be not outputted, the computing device refusing to allow printing of the coupon or electronic redemption of the coupon

23. The one or more storage media of claim 21, wherein the distribution instructions includes data indicating a number of times the coupon may be outputted.

24. The one or more storage media of claim 23, wherein the one or more instructions, when executed by the one or more processors, further cause performance of:
in response to each of a first two or more requests to output the coupon, the computing device determining that the coupon may be outputted based on the distribution instructions;
in response to each of a second one or more requests to output the coupon, the computing device refusing to allow printing or electronic redemption of the coupon based on the distribution instructions.

25. The one or more storage media of claim 23, wherein the computing device stores data indicating the number of times the coupon has been printed or electronically redeemed, wherein determining whether the coupon may be outputted is further based on the data indicating the number of times the coupon has been printed or electronically redeemed.

26. The one or more storage media of claim 21, wherein the distribution instructions include restrictions based on one or more of: a state in which a user associated with the computing device resides, a zip code in which a user associated with the computing device resides, an expiration date, an item to which the coupon is limited, and a discount amount to which the coupon is limited.

27. The one or more storage media of claim 21, wherein, if it is determined that the coupon may be outputted, a) the coupon is printed based on the coupon data.

28. The one or more storage media of claim 21, wherein, if it is determined that the coupon may be outputted, b) the coupon is redeemed electronically based on the coupon data.

29. The one or more storage media of claim 21, wherein the distribution instructions are received in the coupon data.

30. The one or more storage media of claim 21, wherein the coupon data is a data structure comprising at least one or more textual or numeric fields and one or more images, both of which specify information about the coupon.
